(19) United States
(12) Patent Application Publication
(10) Pub. No.: US 2008/0033857 A1
(43) Pub. Date: Feb. 7, 2008

(54) Pooling data for consumer credit or debit cards

(76) Inventor: Manuel Brad Moses, Belle Harbor, NY (US)

Correspondence Address: Steven Horowitz, Esq., 295 Madison Avenue, Suite 700, New York, NY, 10017, US

(21) Appl. No.: 11/906,639

(22) Filed: Oct. 3, 2007

Related U.S. Application Data
(63) Continuation-in-part of application No. 11/113,425, filed on Apr. 25, 2005.

(51) Int. Cl. G06Q 40/00

(52) U.S. Cl. 705/35

(57) ABSTRACT

A consumer data credit card or debit card or personal computer wallet linked to an Internet master catalogue of products. The consumer data card empowers the small credit card or debit cardholder against retailers, by mining and analyzing their consumer profile data, for anticipated purchases, and then leveraging the consumer's offers on specific products, for group discounts. It uses a new business method for pooling, options, and brokering dispersals of consumer's offers to retailers; via the Internet for price discounts. The consumer's card is encrypted as an origin code, for privacy, of their personal consumer profile data being dispersed. The master catalogue is linked via the Internet to remote computer display kiosks, at shopping and information stations, allowing for in-store display of discounts; geared to specific cardholders, and to facilitate in store shopping and checkout; by the personal computer wallet and allowing worldwide virtual shopping.

### PRIORITY INFORMATION

This nonprovisional patent application is a continuation in part patent application of Applicant's pending U.S. patent application Ser. No. 11/113,425 entitled Consumer Data Credit or Debit Card, filed Apr. 25, 2005 and incorporated by reference in its entirety.

### BACKGROUND OF THE INVENTION

The present invention generally relates to credit card processing and the banking industry and in particular the pooling of data for credit and debit card transactions by consumers.

Discount web sites exist that allow for bidding on prices. In addition, there are credit cards having multiple rewards. There are also well worn general business methodologies in the field of bargaining, haggling, and advertising. The prior art relates to the credit cards, electronic wallets, and e-commerce as they are used on the Internet, including Internet discount shopping. Bulk sales and associated discounts are also well known.

In regard to credit cards, it is competition for market share that is driving direct money back rewards, for example, providing a discount of 5% money back on all purchases.

Consumers require more than simple rewards or discount web sites. Consumers require a consumer data card that is a guardian of the consumer. The regulations of the industry are such that they favor the bank. See, e.g. Smiley v. Citibank, (S.D.), 517 U.S. 3735 (1996). This case permits the Comptroller of the Currency to set interest rates that banks can charge, even if those laws may be considered to be usurious in many states. The credit card industry—like any corporation—is more interested in the bottom line than in the average consumer—always seeking to maximize profits. Recently appearing on the Public Broadcasting Show “Frontline,” Senator Christopher J. Dodd of Connecticut, has warned the banking lobby to be careful of their aggressive activity, lest a populist back lash resulting in harsh legislation being passed to protect the consumer against high interest rates and minimum payments that can take years to complete.

The average consumer has no advocate to really leverage spending data against large corporate retailers. There is no business methodology to help them do this There is a need for a method or system to help empower the consumer in the consumer's negotiation with large retailers.

Credit card processing is a good and necessary part of our lives—making credit convenient and instant. There is an enormous amount of data that is daily complied on all our credit transactions, through the main credit reporting agencies, Transunion, Experian, and Equafax. This takes place while the cardholder is largely unaware of just who has access to their personal data. That personal data is their valuable commodity, yet the consumer receives no fair benefit for it.

The greatest benefit the consumer gets out of their data being processed and traded—is fraud protection. More needs to be done with this data. There is a new revolution going on right under our noses that is driven by the Internet:

### SUMMARY OF THE PRESENT INVENTION

Today the Internet is that same old Sears & Roebuck catalogue, but more diverse, containing many more products and far more exciting. The present invention takes the idea of online buying and links it to a credit card making use of consumer data in a comprehensive way that teams up consumers against retailers for discounts. Data and their spending power is the only real thing that consumers have of value to leverage, against the large retailers. The present invention analyzes consumers' anticipated purchases, and broker this group data directly to retailers through a computer program of a master on-line catalogue.

While data mining is taking place, it is generally not for the benefit of the individual cardholder, but is related to mailing lists, and demographic target markets for advertising; merely an invitation to deal. This is no more than is common to the Internet or mass-market mailings. This is far from the explosive potential data mining represents that would empower the lone ordinary consumer to speak directly to the teeth of power: large corporate manufacturers. Here they do not face the tiger alone.

Now imagine billions upon billions of consumer transactions, as a language. A language that can predict the purchases the consumer will buy or their credit worthiness, their demographics and the specialty goods they desire. Imagine a credit card that teaches the consumer how to speak this language directly to product suppliers; making them compete for this business. How important is marketing information to the large corporation today to drive sales? How important are confirmed hot leads to the survival of a business? It is everything. Those leads come from the consumer data card in the business methodology to be described.

An electronic wallet of the future is important is a credit card or debit card, which is described here as a consumer data card. The consumer data card may contain a history of all the consumer's spending habits: past, present, and that anticipated for the future. We then take their individualized consumer profile and create a far more detailed system of classification, for their spending habits; determining their potential or anticipated purchases.

We classify a universe of products in an Internet master catalogue: everything they spend money on—gas station, insurance, supermarkets, loans, retail products (“Hot Brands” and “Best Buys”), utilities, and service providers. Within this business method we update and embed their anticipated purchases into the system of product code identifiers. Including highly specific offers on existing products, as may be found in the Best Buys section and Hot Brands section of our on-line catalogue. Then we take those offers and pool them for discounts or options to buy. This is known as creating an open pool: which invites additional offers. We leverage their data against the big product suppliers for discounts. We become a guardian of the consumer. We start a revolution . . . We have special rewards that cannot be achieved by ordinary credit cards, merely from a good merchant relationship, as can be found with American Express. Origin Nation goes far beyond that, with group discounts to the individual so that all purchases: the cardholder's use of the card for all things they spend money on, become their own rewards—far more profound—in direct pricing for highly specified offers for products below retail sales prices. This is something other major credit cards cannot do. A system methodology of the consumer data card proposed herein can.

We create a new credit card instrument having long-term beneficial use for the average consumer. Instead of a windfall for banks, we create a win-win situation for consumer and product supplier. We save the consumer money and drive retail sales, in a saving, which can also be realized by business card holders. The consumer data credit card creates a long term, more responsible use, for credit cards in a largely unregulated banking industry.

### BRIEF DESCRIPTION OF THE DRAWINGS

FIG. 1a is a portion of a flow chart for a method of the present invention spanning steps 100 through 140;

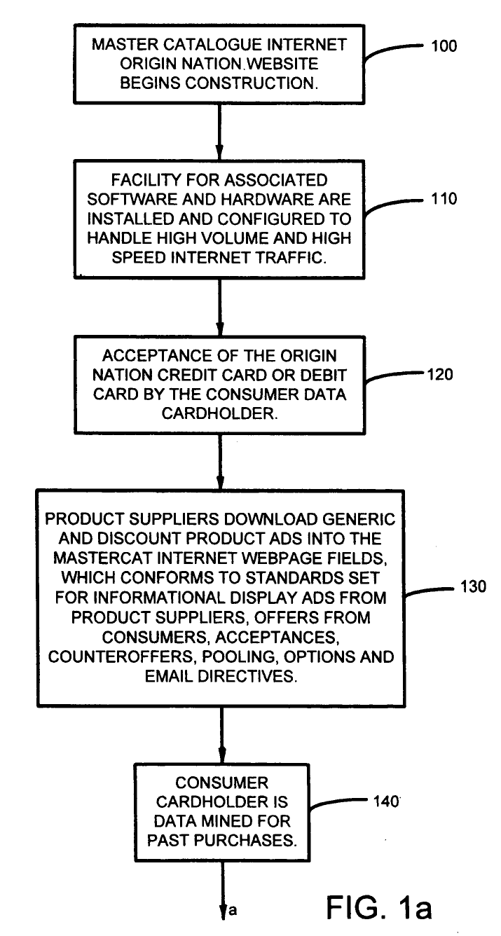

FIG. 1b is a portion of a flow chart for a method of the present invention spanning steps 150 through 180;

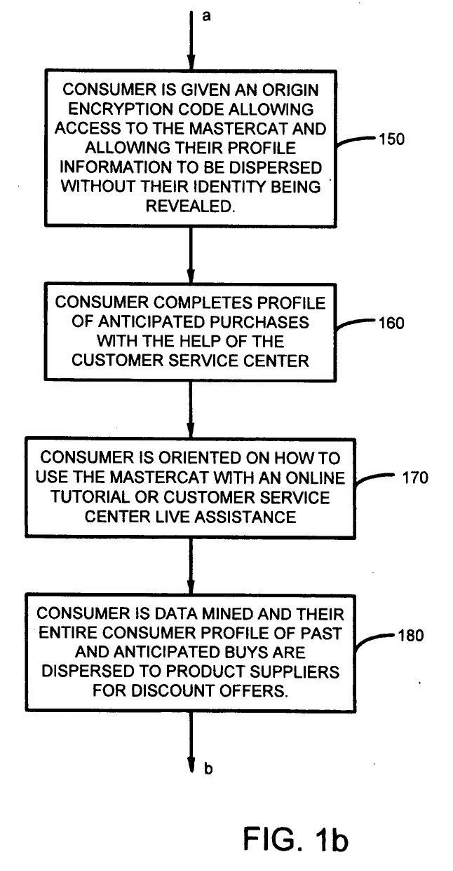

FIG. 1c is a portion of a flow chart for a method of the present invention spanning steps 190 through 220;

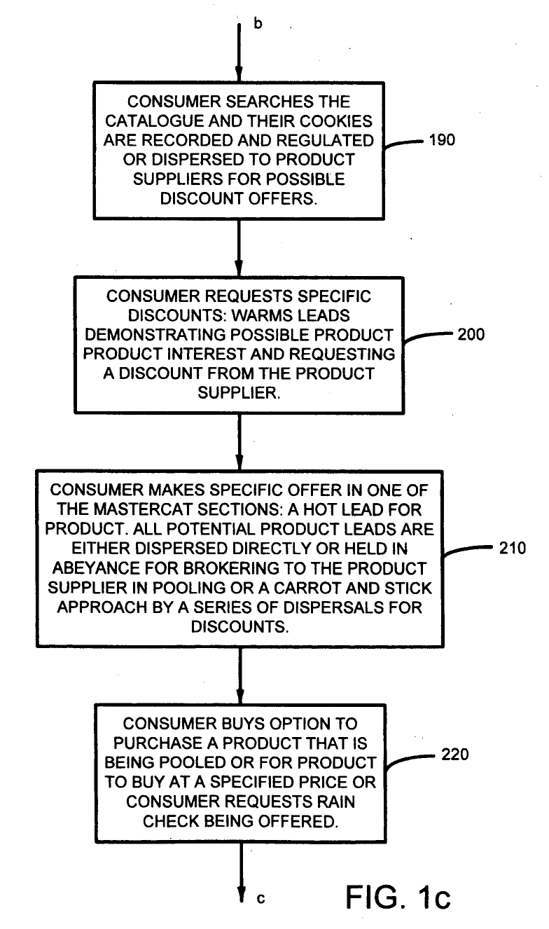

FIG. 1d is a portion of a flow chart for a method of the present invention spanning steps 230 through 270; and

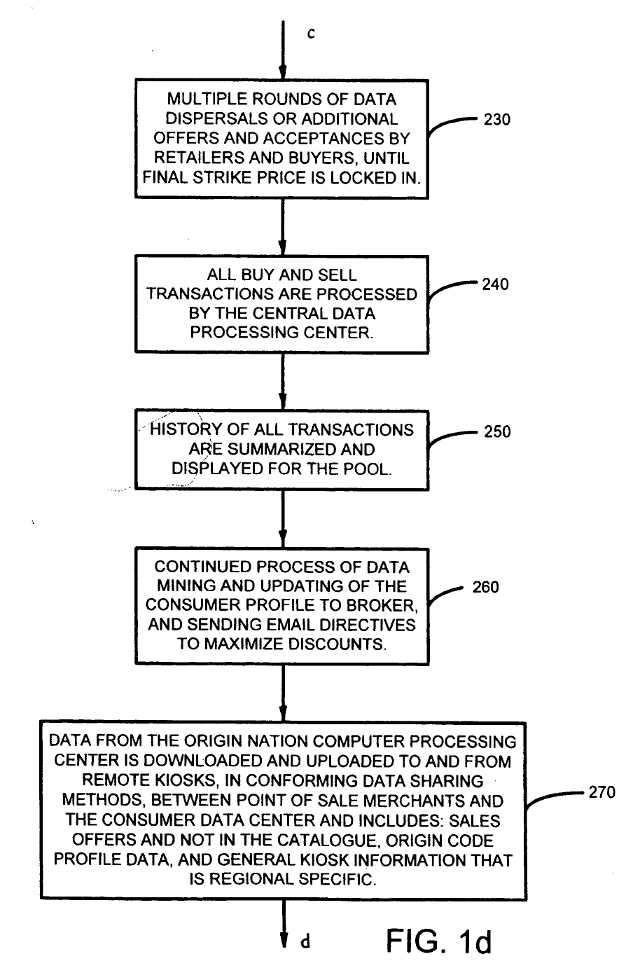

FIG. 1e is a portion of a flow chart for a method of the present invention spanning steps 280 through 310.

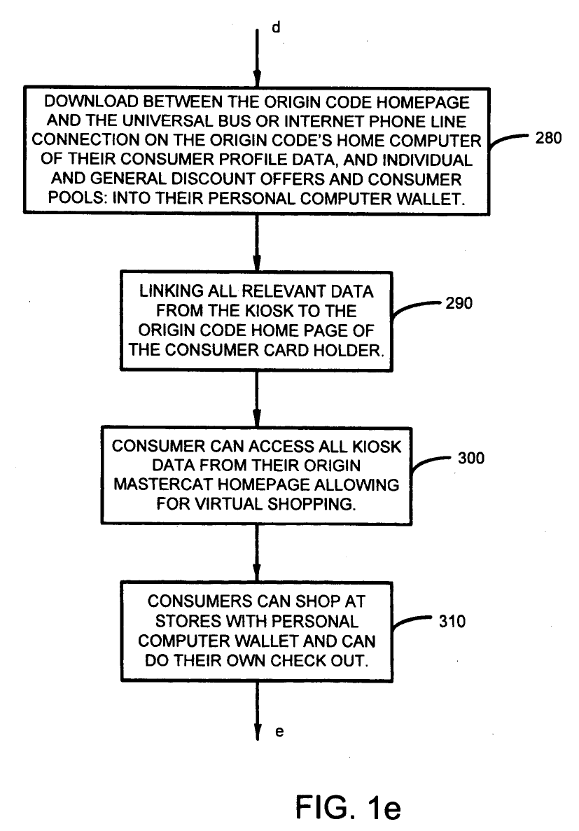

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Step 100—Construction of the master catalogue on the Internet, to house a universe of products, goods, and services; it must contain the appropriate computer based language; laying the foundation for all the features described in this patent and be accessible on any home personal computer.

Step 110—The central data processing facility for associated software and hardware: must be able to handle a high volume of global Internet traffic, from both personal computer users, and for high volume incoming data streams, and large outgoing data dispersals. It should also function to analyze incoming data, and route outgoing data of all products, goods, and services, offers, counteroffers, and acceptances.

Step 120—Consumer card acceptance is unlike an ordinary consumer credit card acceptance implying an in person customer orientation to explain all the functions of the card and Internet master catalogue usage.

Step 130—Product suppliers download their product data into flexible fields of web pages on the Internet; with the cleaning, cutting, editing, sizing, and final arrangement of catalogue done by consumer data processing center conforming to the anticipated catalogue usage, for all required fields and catalogue sections.

Step 140—Data mining of the consumer for creating a standard profile of repetitive use products, and repeated point of sale merchant visits. Profile is adapted for use in the “My Discounts,” section of the catalogue.

Step 150—Creation of the Origin Code: permanent origin code encryption of the consumer profile; allowing the consumer data to be dispersed without revealing the consumer's actual identity. The consumer Origin Code is housed in the central data processing center. All information filtered about the consumer and sent over the Internet is linked to this in-house code. This is the access code to the consumer's home page. It is only entered one time on the home page—then a secure access link is remembered by the computer that blocks the actual code from being revealed ever again. In data dispersals this Origin Code is randomized with a return link to the actual code in the central data processing center.

Step 160—Consumer completes data profile survey on line or initially via a customer service representative interviewer who enters the data for them in their Internet survey form.

Step 170—Consumer is oriented with a downloadable streaming video display on how to use the master catalogue or simple on line set by step click on tutorial.

Step 180—The consumer profile is data mined for anticipated purchases—per the survey—and the updated data mined profile is activated.

Step 190—Consumer's search of the master catalogue and other Internet based product searches are recorded, for data profile updating, and this information is dispersed to specific product suppliers, so that new discount offers in the “My Discounts,” section of the Internet master catalogue are regularly updated.

Step 200—The consumer is able to click on a link or product to demonstrate a warm lead; requesting a discount from the product supplier, allowing updating of the “My Discounts,” section of the Internet master catalogue.

Step 210—All hot leads are analyzed by the consumer data processing center before being dispersed to the product supplier, for potential pooling or brokering to achieve maximum discounts.

Step 220—Options are available for various posted prices and are generally associated with pools. Rain checks are by displayed openly on the Internet or by direct request to the manufacturer from the consumer card holder and generally have a shorter life expectancy than an option. A system for posting options and rain check requests must be either open to the entire master catalogue or associated product supplier via a data dispersal or direct master catalogue link or be totally processed as opaque to the master catalogue and come in directly to the data processing center for dispersal notification via email.

Step 230—Multiple data dispersals are product supplier specific. This means that the product supplier has to have a data receiving center for processing multiple offers. This strongly implies—they are a large chain store or large manufacturer. If the product supplier is not equipped to process the data then this can be accomplished by their general posting of a counter offer or through their assigned personal computer agent and our central data processing center. The product supplier can also set guidelines for counteroffers to be accepted, and the central data processing system can process all acceptances or counter offers on their behalf following those established guidelines.

Step 240—All buy and sell transactions are processed either by the central data processing center or the regular credit card processing entity.

Step 250—This figure requires a graphic illustration that would in summary chart the history of the transaction. A separate section can exist for this purpose, of such summaries, and further summaries can be so illustrated in a further combined form. This would provide general indicators for pooling in certain important sectors such as: automobiles, computers, and insurance products.

Step 260—Continued processing of all incoming data on consumers; taken from multiple, internally generated sources, and outside sources, including the full spectrum of associated demographics; not merely individual specific—but relevant to creating the consumer's regional profile. This data mining is also in reverse, and global in reach, of product suppliers, for invitation into the system for their products or upcoming products and their associated sales statistics. We also use a system of email alerts for product discounts, and information on making product offers as pool participants and other important information from the central data processing center, which goes directly to the consumer.

Step 270—Data from kiosks is always coming in from site specific regions; data is continually going out to those remote computer terminals. This kiosk information is sectioned off into a specific section of the Internet master catalogue. This data includes high content graphic information. All data is processed through the central data processing system—although in some cases certain data from the kiosk may not be processed from the kiosk into the open master catalogue—by agreement- to get the credit card holder to go to the store for their specific discounts not displayed on the master catalogue.

Step 280—There has to be a link between the personal computer and the personal computer wallet. Generally, that link will be via the universal serial bus of the personal computer, but can be through the high speed or internet phone connection. This will allow for rapid data transfer into the personal computer wallet. Allowing for the preconfigured sorting functions of the wallet to be activated; this pre-configuration will also come through the master catalogue itself; sorting shopping lists and displaying their discounts for requested stores to aid the shopper.

Step 290—This kiosk data needs to be sorted for relevancy. The consumer card holder should be able to accomplish all the search functions, when at the kiosk as they can accomplish, when searching the master catalogue on their personal computer.

Step 300—Linking all data from the kiosk has an ultimate goal: allowing for virtual shopping and walking the consumer down the isles to a specific product, and examining that product, as if in the actual three dimensional store. Initially this will be only in two dimensions on a computer screen and over the Internet or without an actual virtual walk through to the product—at all—but still containing much relevant store or regional shopping information to aid the consumer in planning their shopping, events or vacation trips.

Step 310—Consumer is able to deactivate the electronic product tags on products. It starts by activating a pin code in the personal computer wallet. Now products which are deactivated are also transacted as buys, and recorded into the personal computer wallet as an LCD paid receipt. Now the consumer can exit the store with deactivated products; allowing their LCD display to be examined by security. Instead of a product tag deactivation the personal computer wallet can include a bar code scanning capability, and the LCD display would likewise be activated recording sells for security to examine at the in-store exit.

An Internet Master Catalogue web site is referred to herein as the “MasterCat.” It is a master catalogue of retail products, goods, and services: (product suppliers.) These were product suppliers who have agreed to be a part of our catalogue. At first they will be large retail chain stores, large corporate manufacturers, and a plethora of other certified product suppliers who meet our criteria for quality, return policies, and method for handling consumer disputes.

The MasterCat is broken down into the following main sections: “Best Buys,” “Hot Brands,” “Pools,” “Competitive Bids,” “My Discounts,” and “General Product Catalogue.” The Best Buys section contains rated product information compiling products that generally cost over 100 dollars and typically cost over 500 dollars. They are rated products with associated product information not usually found in the other parts of the catalogue. They are open for large scale offers from consumers in the form of pools.

The Master Catalog may also include a section called Hot Brands that contains brands that are popular in the marketplace, and ones that are open to potential pooling others that are not but are discounted.

The Master Catalog may also include a Competitive Bid section conducive to products like, supermarkets, gas service stations, insurance products or loan differing loan interest rates, individual and group travel, online entertainment—although any product supplier can be in this section. It is a section that pits one product supplier against another and is conducive to pooling of consumer offers.

The MasterCat can be searched by the consumer cardholder from their “Origin Code” homepage and the following click on links: to product categories and the associated stores carrying the product; a link to the specific chain store, a specific store or a specific product in the store or advertisement. The search can also be by classification of product types. The search can also be by key word search or MasterCat product code search. Each section can be searched individually searched as the general catalogue.

The Internet profile data of anticipated or past consumer surveys results in solicitations from the product supplier for discounts—especially when an anticipated buy: this is a fill, if the profile has no anticipated purchase survey loaded: this is a gap in the consumer profile. To access posted discounts in the catalogue you need not have even completed a survey. The survey is only a function to cultivate direct offers from product suppliers. It is a way the consumer has to control solicitations and special offers for a consumer hot lead and a method for the data processing center to determine hot leads for data dispersals and the creation of open pools.

Gap and fill information can be displayed in graphic easy to read displays or in highly specific terms associated with specific product(s) the consumer desires to buy. You can open a catalogue and see if such a product is “loaded” for your profile as an anticipated buy. The consumer can wipe their profile and store it for later restoration. The consumer can update and change their profile. The consumer can wipe parts of their profile or restore parts. You can delete parts of your profile permanently or in the alternative only with permission of the central data processing center. For example, you cannot delete data of your past buys, but you can delete the ability to have future dispersals based on data mining of your past buys or anticipated buy, which completely stops unwanted ads.

The consumer can also control solicitations more quickly and easily by a simple general category switch for on and off, which controls their incoming ads. The consumer can also stop all solicitations—at once. The consumer is given the option of controlling not only the number but the quality of solicitations they receive: number in the specificity of the products they desire solicitations on; executed by simply clicking on broad product category(s) or a general store chain logo or brand(s) or specific products or the associated icons or express representation of the product itself.

The consumer can control the quality of the ads it receives: related to content and form. Primary examples include—streaming video, pop up ads, broad window display encompassing reduced or wide screen angles of viewing, amplification of product or if the retailer downloaded appropriate content in the ad the consumer can control various multilevel views or 360, degree views of the product, split or multiple screen viewing, informational crawls, enhanced virtual shopping through remote computer in store display kiosks and all the associated benefits of the Internet content driven revolution.

In the alternative the data processing center regulates the quality and content of all ads. All information downloaded into the MasterCat is thoroughly scoured for viruses, and must conform to standards set for the MasterCat to prevent hacking and computer viruses being spread to consumer Internet surfers.

The incoming email of the consumer shall be closely regulated. We will never give out the email address of the consumer—least we risk spam and loose credibility. All email messages will be regulated through the MasterCat homepage. Only in very limited circumstances will data dispersals go directly into the inbox of the consumer, for example, a reminder of a high dollar value offer, and subsequent notification of a counter offer from the product supplier. In the alternative to simplify correspondence emails can be direct from product supplier to consumer—especially for time sensitive pools- and high-ticket value items, when the consumer has direct questions to the product supplier.

The main methods for posting ads in the Internet MasterCat include: downloading directly from the product supplier an ad catalogue web page, which can be formatted as follows: a store link, a product link in the store, a product, icon link, a data stream link of the product (for video ad display), a display window of the product, which includes product description or a page of associated product icons in the store category other means of display are flexible for artistic reasons and for reasons of efficient organization of icons and quick viewing products.

The ads from product suppliers must be able to incorporate a field for posting data related to creating a consumer offer pool: (price offered), and posting counter offer (from product supplier), time limit for the pool, and final strike price, and associated overall statistics for the transaction. The ads should incorporate an email message link for directives from the central data processing center on recommended offers for cardholders and other pooling directives. The ads should incorporate an email link, directly from the central data processing center to the product supplier for related pool information and brokering consumer data. So it will be important to have dedicated management in the product supply pools with decision making power able to respond—in almost real time.

The consumer can also allow us to track their Internet cookies for continued data mining and solicitations. The consumer can allow store web pages to individually track their cookies and products they view, when they visit their store web page. In the alternative the consumer can turn off all cookies or allow cookies for one or more products. The cookies become a part of the mined consumer data profile. It is an easy control mechanism on the consumer's home page of the MasterCat, but can be simply activated anywhere in the catalogue for a product or products.

There needs to be a series of internet servers and associated routing for transferring real time, high quantity data, into the central, data processing center, and for dispersing real time, high quantity data, out to retailers and cardholders or large scale, credit card processing company who processes the actual buy sells. All systems of all computers in the central data processing center should be protected against, hackers, and viruses. Its dedicated lines should be multiple and secure for data transmission and the data processing system should have multiple back ups to prevent crashing or a system data overload.

Once the catalogue system is in place, we are able to begin the process of establishing consumer data credit cardholders. It starts with the credit card acceptance, an understanding between the card servicing data center and the consumer. It is an alliance with the consumer: we create a consumer profile of their spending habits, past, present, and those anticipated for the future.

Initially the consumer completes an online questionnaire or in person or telephone interview conducted by a customer service representative that will last about 20 minutes to complete. This questionnaire includes information about where they regularly shop, what are the product brands they regularly buy, and what are their anticipated purchases for big-ticket items in the coming year. We also ask them to supply us with information on all the rest of their periodic bills, examples of which include: insurance, mortgage, loans, utilities, movies, Internet service, and more.

Now the credit cardholder is assigned an “Origin Code.” This is defined as the true code known only to the consumer and the data processing center: it is the consumer's identity for use when they search the Internet master catalogue of products goods and services (product suppliers.) At all times the circulated identity of the consumer or their “Origin Code,” is seen by all other parties during E-commerce web page viewing or email communication—as an encryption.

This encryption of consumer profile data allows the consumer to feel comfortable about revealing their consumer profile data of anticipated and past purchases to all relevant product suppliers. The consumer remains unknown until they accept an offer. Hence we call the card, “Origin Nation:” a card global in character comprising millions of Origin Codes or cardholders from many nations. It should be noted that the term, “Origin Nation” is an aesthetic term of art, not a technical term of art, and may be any name designated by the central data processing entity or organization which controls, analyzes, and disburses the consumer data.

The Origin Code is the code a cardholder enters to allow entry into their personalized online Internet master catalogue or “MasterCat.” It can be a personalized with the name a consumer chooses or one with alphanumeric meaning for routing, collecting, and processing the individual consumer's data. When they do accept an offer—only one specific part of the cardholder's profile is revealed—never their master Origin Code or true identity: this is the personal code allowing the individual access to the computer MasterCat. The is a desirable feature as evidenced by the popularity of “Spyware,” “Firewalls,” and “Virus Scans,” which prevent unwanted intrusions.

Now the consumer has access to their online catalogue. The first step is to orient them to the catalogue with a tutorial or with access to a telephone customer service representative who can also answer their questions on how to update their consumer profile for anticipated purchases, and walk them through the Internet MasterCat and its associated functions.

We help the consumer to build their consumer data profile: consisting of past and anticipated purchases. It is a means of gaining more detailed information building in specifics on information gleaned from the in-person or telephone survey. The online questionnaire is based on product categories, where they shop, and what they anticipate to buy in the near or distant future or for those who it suites best; the survey is simply completed by a 20, minute telephone interview that is keyed into the Origin Code profile of the consumer cardholder.

The Internet online questionnaire is also keyed into the consumer data cardholder's consumer profile. And we regularly ask for updates of the consumer profile for specific categories or in total. An important part of the questionnaire asks about the consumer's present possessions or planned big ticket spending items: for example, age of car(s), household furnishings, planned vacations: including information about anticipated date of departure and return for competitive charters or anything they anticipate spending money on, including health and life insurance.

Now the consumer's MasterCat Internet catalogue is activated; they begin the process of receiving solicitations and searching the catalogue. We track their cookies. We also begin the process of advising them by an email welcome of how email directives work to their benefit, when pooling their offers with others and searching and using the MasterCat. The email directives come into their message center on the home page of the catalogue and directly into the product pool web page, so that they can simply and quickly get real time information on the pool (this is particularly important if it is a short term, fast moving pool), when for example, there is a limited supply of a “Hot Brand” product.

Email directives are posted directly to the Origin Codes in their inbox or on the web page pool: for example, a recommended price for initial offers is displayed. This is determined by the total number of anticipated purchases that will come in based on data mining, surveys, past sales or after consultation with the product supplier. Now a pool is established wherein data is collected for a series of dispersals to the product supplier; to leverage and broker incentive—in a carrot and stick approach—to achieve the lowest possible price for all people in the pool.

There are three types of leads that can come in to the data center, as offers from cardholders: 1. Hot lead: defined as a confirmed lead to purchase at a specific discount price. 2. Warm lead: defined as a potential offer below the recommended price or a desire for a rain check at the recommended price (if a rain check is being offered.) Both of these leads can be brokered to the product supplier. 3. Option to buy: if no rain check exists this option can be at any stated price and, of course, have an associated cost. Lowest priced option is the initial, first round, recommended price offer. Most expensive, any option at or below the strike price: defined as the final price for all accepted offers for the entire pool. These options expire after a specified period of time and may be transferable or in the alternative non-transferable depending upon custom and use and how it effects the competitive health of the general market processes.

The following is a streamlined example achieving the stated goal—for an “Open Pool:” all product leads would come in without any restrictions or guidelines and be dispersed to the product supplier either directly or in a series of dispersals from the consumer data center—to broker—for the lowest possible strike price. The inauguration of an open pool may include recommended price offers from the central consumer data processing center or no recommendations whatsoever such as for a hot brand with a limited supply.

Counter offers or acceptances can come from the merchant directly to each cardholder or through the consumer data system or in open price posting counter offer on the Internet or in the alternative come through the cardholder data processing center via email posting to the Origin Code or posted in the Origin MasterCat product page as a more direct method. All postings and counter offers can be accomplished with the same methodology for open and regulated pools. This way the lower the offer for the pool is data the product supplier can see as confirmed firm leads and to speed up the process of confirmed hot leads—lower the price—of their own initiative. These series of offers and counter offers can go through one or several rounds with all participants in the pool benefiting equally or differentially at stated levels of confirmed acceptance. Probably an equal beneficial strike price will prove the best long term business methodology for achieving initial strong interest, as opposed to a wait and see how low it goes approach. This will reveal more about the actual nature of the market of potential buys for all concerned.

In a freer approach, pool creation may be accomplished by the data cardholders themselves, if set for a specific click on the product itself or check box interest in the appropriate section that the product be pooled. Then the offer criteria can be entered in a simplified form that requires the consumer cardholder to enter a firm price offer to buy at a specified price. As appropriate we can also form chat rooms for discussion of patrons looking for other members to form a pool. For such a process we may issue general guidelines at for example, 10-20 percent below the retail price. We will not sell options until a pool is established. All pooling requires the participation from the retailer. Options are fees shared with the product supplier or in the alternative not shared and the retailer takes all or the consumer data center takes all or part.

Under the pool creation data may be sent directly to the product supplier or be brokered through the consumer data processing center. Probably the more expensive items will require more brokering and more rounds to achieve the best price. Of course this is also largely determined by the marketplace and existing demand: seasonal air travel and chartered flights versus a new model of car versus a newly released movie.

The “My Discounts Section:’ may include those specific offers from product suppliers that are geared to the data profile of the individual cardholder: the results of data mining, surveys, and telephone interviews. They provide incentive for the consumer to regularly update their profile. Pools from various products can be in this or any other section of the catalogue. Pools as a separately organized section can be assembled and searched by the consumer cardholder.

The “General Sections,” of the catalogue may include discounted and non-discounted products. All products have to potential to be probed for discounts by individual request to the manufacturer or by pool formation.

The “Consumer to Consumer” sections of the catalogue may be a form of used furniture classified. It allows the—consumer to consumer—communication to take place, for any product, good or service that you can find in the classifieds. As in any part of the MasterCat searches are the same for building a consumer profile for anticipated searches or doing a keyword search for a specific used product.

All consumer to consumer products are associated with a designated bar code in the MasterCat. This allows for simple confirmation of receipt and payment by the seller and purchaser. In the alternative no bar code is used and products are merely paid through the security already provided by the origin encryption. The same process exists as in other parts of the catalogue for offers, counteroffers, and acceptances.

Kiosks are computer display terminals. They are typically found in large malls, chain stores, tourist locations or anywhere where shopping, and entertainment is important. They can be artistic branding displays serving the trademark needs of the locality or store. They can be in a local café or bookstore. They serve more than simple advertising displays. They are also data centers geared to the specific Origin Nation cardholder.

The kiosk is a high-speed Internet connection and potentially linked to an Automated Teller Machine. It is touch screen and can include a typewriter keyboard for more complex search functions.

The kiosk will have all the store specific discounts for the origin code who enters their origin code. Activation of the profile should be by direct, secure link to the “Origin Nation,” computer processing center. In this way the actual origin code of the individual would remain unknown to the local store but still allow access to the kiosk.

As one incentive to get customers to make an in store visit the in store display may only have discounts that can be accessed with an actual in store visit. This will also differentiate discounts to locals and provide added incentive to have the costs associated with the kiosks.

The kiosks are linked to an electronic hand held wallet. This is in reality a personal computer wallet. This personal computer wallet contains all the important information of the consumer profile, which is contained in the Internet MasterCat. It has a large liquid crystal display for surfing the Internet. It can also function as a cell phone and has the added feature of a small keyboard or more simply be operated by touch screen display.

It has a universal serial bus for downloading data from the MasterCat that is specific to the individual consumer data cardholder's profile. It can also be connected to the Internet, for the same purpose, via a low or high-speed wireless telephone Internet connection. With the added feature of a high data capacity personal computer wallet, which functions as a miniature hand held hard-drive. The wallet can take the form of a fashion accessory but its primary importance is to function wallet sized—able to fit into one's pocket.

The wallet may contain the consumer data cardholder's profile and catalogue. In an abbreviated slimmer form it may simply function as a far more advanced smart card, able to be connected to a universal serial bus or Internet connection on one's home computer for downloading data related to the MasterCat and their consumer profile. In this means it would be a card able to fit into one's wallet. Moreover if the serial bus were far more smaller it would make the card slimmer or the card may simply function like a more advanced smart card that has a similar data capacity to a flash drive, and be able to be carried on a key chain. If functioning as a smart card then the card would function more to allow access to the Origin Nation central data processing center than be programmable itself.

The personal computer wallet would be one, which is helpful to the consumer in more ways than simply displaying their discounts directly or as they surf the Internet or view their information on a remote kiosk. It would provide information on shopping lists and sort their associated discounts of things on sale where they regularly shop: like a personalized circular.

The personal computer wallet could have the added feature of functioning as a cell phone or contain downloaded music or video. It may be connected wirelessly to the Internet or have receivers for satellite radio or have saved downloadable music. It may be connected wirelessly to remote activation devices and unlock your doors or shut of your lights or start and warm up your car on a very cold morning.

The personal computer wallet linked to the consumer data card would allow the consumer to maintain control over their individualized profile, giving them an important sense of control over their data. Through the wallet, as previously described, they can control solicitations and wipe their profile in whole or in part.

The wallet may also have theft guard features, which allow for remote deactivation or activation of a remote self-contained alarm or locator. Interestingly these features may be very important for the elderly who are home bound or hikers who are lost.

The wallet may also contain a bar code reader and product tag deactivation scanner: allowing one to deactivate an in store product tag allowing for product search and buy without ever having to speak to a store worker to find the product or go through check out in the following manner:

Enter the store and activate your wireless pin code on the wallet. Go over to the kiosk and request the location of a specific product. The kiosk will walk you to the product location in the virtual store online. The consumer data cardholder then walks to the product location deactivating the product by scanning the bar code or deactivating the product tag with the personal computer wallet. Having set their pin they can now exit the store as their transaction has already been registered. Store security can view a simple proof-of-purchase receipt on the hand held computer of products purchased. If the customer wants a hard copy or rebate coupon they can merely print it later.

An important and exciting aspect of the remote kiosk is the ability to shop remotely! The kiosks are connected to the Internet. You can click on any kiosk in any store location in the world and be walked down the isle to the product as if walking through a virtual store and buy that product for shipment to your home. You can get advanced shopping and travel information from the kiosk—instantly—weather, travel information of airlines, traffic, hotels, and much more, and all in your own language.

In an embodiment that further develops the concept of the present invention, the product supplier may also be able to directly fix the percentage of discount in the Master Catalogue of products, goods, and services.

The Master Catalogue may be linked to various sources such as the Central Data Processing Warehouse (“System”), the Internet, land lines, a Personal Computer Wallet, credit cards, cell phones, kiosks, computer software or computer programs, wireless devices or electronic screen amplifiers An example of a screen amplifier is a device affixed to a shopping cart displaying the store's circular or wallet.

The Master Catalogue information may include information from a print circular, advertising material, or any other information displayed on devices typified by human command activation. For example, such devices may be controlled by a keyboard or voice command. These wireless devices may display the Master Catalogue and information may be controlled by the merchant, product supplier(s), or the central data processing warehouse.

A.) In certain preferred embodiments, the invention allows for the listing of confirmed offers that would generate a specific price discount for a product, product category or department of the store;

B.) In certain preferred embodiments, the invention attracts consumers into the product pool by decreasing the price as more customers make confirmed offers until a certain strike price is achieved for the entire pool;

C.) In certain preferred embodiments, a pre specified percentile discount on all items may be achieved if the consumer is willing to guarantee spending a pre-determined amount of capital at a store (may also be known as prepay);

D.) In certain preferred embodiments, consumers receive a specific percentile discount based on a requirements agreement for all products the consumers will use during some pre-determined period of time. The period would be renewed automatically based on past product usage or the anticipated consumer requirements. These requirements may be adjusted;

E.) In certain preferred embodiments, the amount of pre-dedicated capital can be brand specific. This pre-dedicated capital may apply to a specific category of products made by a particular manufacturer;

F.) In certain preferred embodiments of the present invention, statiscal analysis of a large group of consumers is performed to determine their product consumption rate and any associated standard statistical deviations of the sample. This information may be used to reorder for larger consumer groups and thereby achieve greater discounts for larger groups under the Central Limit Theorem. The Theorem is defined by statisticians as measuring how much your sample mean will vary without having to compile other sample means for comparison. This embodiment may include fixing a time limit for the consumer pool(s) of these dedicated consumers, and locking the pool down with a one way membrane of fixed offers and acceptances with a gradual declining discount for the entire pool. [It should be noted that this claim's uniqueness and all its consequential benefits are not based on the Central Limit Theorem itself as it is a common statistical device. Rather, the claim's uniqueness and benefits are a product of the functions derived from applying the Central Limit Theorum and statistical confidence intervals to consumer bulk purchases, product suppliers' offerings, and associated Central Data Processing Warehouse advisement in order to update and fix the economic architecture's predictive model forecasting production, sales, and consumption.]

G.) In certain preferred embodiments, the consumer pool is not locked down and can be captured by another product supplier, in whole or in part, pursuant to a better offer. As a consequence, the remaining fragmented pools can regroup, in whole or in part, with offers free floating until a final strike price is locked down for the pool;

H.) In certain preferred embodiments, the pool(s) can be locked down, and not open to capture as a requirement or incentive for the product supplier to have the pool formation begin or drive the initial dedicated open price of the pool to an attractive low. These pools would be subject to cross referencing by statistical averages of past pool runs for the same product or generic product type to determine if a lock down pool is opening low, medium or high. An associated alert signal may then be sent to the consumer based on past objective criteria. Examples of such signals may include a flashing green symbol, signaling for investment, a yellow symbol for investing with caution, or a red symbol, warning against investing in the opening pool price. These recommendations would not favor one product supplier over another or prohibit either the consumer or the product supplier(s) from submitting offers and acceptances. Any alert may be signaled for any product such as one which demonstrates a one half off discount. It should be noted that a problematic lock down or unlocking of a pool can come at any point in time. For example, a problematic lock down may occur near the point of maximum pool swell or nearing the end stage active attraction of entering consumers. This entire step methodology can be accomplished through the Central Data Processing Warehouse, without the consumer having to make any choices, or by automatically sending data on purchases to the product supplier from the Central Data Processing Warehouse. This can be done directly on all offers and counteroffers with simple confirmation of actually selected goods for purchase by the consumer even at late stage checkout.

I.) In certain preferred embodiments, product suppliers can request offers from consumers to establish their own lock down price. Product suppliers can establish rewards for early arrival consumers that lock down into pool formation. Examples of those rewards include monetary discounts on associated product lines or early reward product options which may or may not be transferable or have monetary value;

J.) In certain preferred embodiments, consumers may form pool offers, as an automated step for desired products and prices. These have been pre-selected either through the Central Data Processing Warehouse or by their own choosing directly through the Master Catalogue. These pool offers may entice the product supplier(s) into either a lock down or a free flowing pool open to capture;

K.) The invention also allows for setting prices for the option to purchase at a pre-specified price in the future or issuing a rain check for the products based on in-store guidelines or objective and disclosed product supplier standards;

L.) In certain preferred embodiments, the consumer data warehouse does the analysis in steps A-K negotiating all discounts for the participating consumer group.

Where the consumer data warehouse conducts the analysis, the Central Data Processing Warehouse can advise the product supplier(s) of the projected consumption rate for any anticipated bulk purchases. The product supplier(s) can allocate the bulk discount through any of the claims in all specifications herein, without the consumer having to even prepay or pre-select their purchases.

In certain preferred embodiments, the product supplier may receive confirmed offers for products that are not yet produced or products that are already produced, but not yet delivered to a point of sale. This would allow the consumer to receive a planning discount and would allow the supplier to base the price on cost projections and capital product funding. This embodiment comprises the following steps:

M.) Allowing the consumer to communicate directly with the product supplier through the Internet Master Catalogue. The communication is intended to make a firm offer in an open pool on a specific product that has not yet been delivered or manufactured, or is being specially manufactured (customized product). This would allow either the consumer or the supplier to specify the future product delivery date;

B.) In an alternative variant of this embodiment, the consumer may use a virtual reality simulator, containing representations of the not yet produced product(s). This simulator may simply be an Internet web site, a high-definition screen or a more complex setup creating a three dimensional virtual experience. A potential universe of items found in the Master Catalogue may be linked directly to the actual stocked shopping isles at the point of sale merchant. More thoroughly, this can be defined, as the graphic exhibition of products within a modular simulator or theatre simulator. This simulator has search and direction functions to the products or listed product suppliers, for the purpose of immersing the consumer in a universe of potential purchase or customization possibilities. This in-store simulator is an immersion into a two or three dimensional or three hundred and sixty degree representation, of the actual brand name products. The consumer's decision to purchase is based on their simulator choices or reliance on past product use experience. One example of a simulated immersion would be sitting and driving a three dimensional model of a car not yet physically manufactured. The simulator also allows the consumer to purchase single luxury items, bulk purchases of specific brands or generic products, products within a family of the same manufacturer or regularly purchased items, sought to be procured at a discount.

C.) The invention further provides data mining updates of the consumer for the items they regularly purchase.

D.) After the consumer's Origin Code, profile data is compiled from the methods previously described in order to anticipate their probable future consumer purchases or actual pre-confirmed choices;

E.) In the alternative embodiments or as an additional enhancement to the described embodiments of the present invention, the product suppliers would have their own simulation related to their product sales strength, projected sales strength, and supply chain production needs. And within the product supplier's field of enterprise, they would receive information regarding their competition's product sales strength, projected sales strength, supply chain production needs, and product pricing including historical summaries of past pool runs and associated competitive projection requirements. They would be able to access all associated pricing comparisons, production facility comparisons, asset comparisons, public filed documents comparisons or disclosed accounting or business methods data (and potentially advise the Central Data Processing Warehouse on systemic methods of discounts). It would also allow the Central Data Processing Warehouse to exhibit background economic data related to purchases in general. The data detail would include a micro economic level of individual Origin Codes linked to the specific projected financial capacity of the individual. In the alternative, this information may be sold to each product supplier or a consumer. It may be sold as part of an umbrella of brand or product consultation services or it may be part of a fee associated with sales and purchases;

F.) An additional enhancement of the invention may involve a personalized virtual store, within the Master Catalogue, which would include information related to the real time price of products as regularly updated by product suppliers and processed through the Central Data Processing Warehouse. This can be region specific which may allow for travel information based on store locations, in-store circular or coupon information, point of sale or product sale or detailed store information and comparisons of prices from various regional stores in the area;

G.) The consumer pre-selects the products or product categories they desire to purchase in, from or by;

H.) The consumer can pre-dedicate money for the purchase(s);

I.) The consumer can pre-dedicate money for the purchases in regularly timed future intervals. The funds will then be electronically withdrawn from checking or savings accounts or funded by the consumer through direct deposit funds transfer;

J.) This has the cumulative effect of allowing the Central Data Processing Warehouse to combine confirmed dedicated offers, for specific products in on-going real time bulk purchases, for the data card holder. The term “data card holder” is interchangeable with the terms “Personal Computer Wallet,” “Master Catalogue” and “check-out register” wherever it is possible to enter/scan/read the consumer data card or recognize the holder's Origin Code and/or associated pin if it is required to access finances or product information for purchases.

K.) In certain embodiments, the Central Data Processing Warehouse may choose to hold a percentage of offers. This may be done for creating a larger bulk pool of consumers for specified products, and pre-dedicating larger amounts of capital for product purchases;

L.) In an alternative embodiment of the invention, the consumer can opt into a tutorial and select the discount methods described in any claim for their data dispersals, solicitations, dedicated capital expenditures, and purchases;

M.) In an alternative embodiment of the invention, the consumer can opt into the consumer data card which allows the automated system within the Central Data Processing Warehouse to pre-select or select the discount in real time for offers in generic categories of products, specific brands designated, as late corners, when in-store, for the product, as they communicate through their Personal Computer Wallet, with the in-store kiosk or check out register or any link to the Master Catalogue.

The in-store kiosks are critical in serving a communicative function to multiple store users at any one time. There may be multiple kiosks at one location. For example, a supermarket may have multiple kiosks because regular price conscious consumers can review their shopping list without having to wait in line and edit choices through their wallet, internet or kiosks. Moreover, the kiosks or Master Catalogue may dispense information on multiple subjects. For example, distributed information may include prices at other stores, travel information to those stores, or something as simple as ingredients for recipes.

N.) The consumer can use cash at the point of sale by having a consumer membership. The consumer simply accepts real-time discount benefits by paying the agreed upon discounted price;

O.) In another alternative embodiment, a consumer can use an automated system which allows the Central Data Processing Warehouse to negotiate within the bulking methods previously discussed and to be described in order to obtain the lowest possible prices for the products selected;

P.) In another alternative embodiment, the Central Data Processing Warehouse is permitted to automatically create a shopping list for the consumer. The list is created in the Master Catalogue, or more directly in their Personal Computer Wallet, comprising items in low supply and products open for discounts from product suppliers via the methods of bulking previously described.

Q.) Some variants of the present invention allow tracking the product purchases and products picked up as displayed in the on-line “pantry” of the consumer. This function is also available from the informational displays of the Personal Computer Wallet. (The information displayed on the Personal Computer Wallet is not necessarily related to data sent through the Internet. Instead, the information transfer may be by a more secure method particularly related to the Origin Code with the associated checks and balances of computer security and comprising Origin Code computer verifications related to the authenticity of any transactions.) The rate of past product usage, as indicated in part by new purchases and product pick ups, also helps determine the future shopping list. The list is used for the immediate pick up of needed products stored in the consumer “pantry” or products that require to be purchased to stock the consumer pantry.

The terms “pantry” and “consumer” should be considered to be an expansive term throughout the claims. The “pantry” is not limited by size or place and may also take the form of an actual warehouse in business to business transactions. The “pantry” may encompass multiple locations allowing transfers of purchased or optioned items in those transactions from pantry to pantry or warehouse to warehouse and from consumer to consumer or business to business. The projections for this step of pantry stocking or reordering come from the Central Data Processing Warehouse's historical data records of past sales and projected purchase records as indicated by consumers or product suppliers' anticipated rates of depletion. It should also be noted that business to business transactions can be in the form of subcontracting production or reciprocal agreements. If a product supplier, or more specifically a store, has a product in stock, then the product may be purchased at the point of sale merchant which is closest in store location to the Origin Code and would thus reduce delivery and warehouse costs.

R.) The device of the present invention may remind consumers in the Master Catalogue or Personal Computer Wallet of any time limits for picking up pre-paid products. The device may also display data related to the items remaining and store locations where the items may be picked-up;

S.) In an alternative embodiment of the present inventions, the Central Data Processing Warehouse may negotiate prices of all choices based on the amount of money pre-dedicated for a prior consumer selection, a prior simulator excursion or the pre-dedication of capital based on the consumer's previous shopping.

At summation of the excursion, the consumer can edit their choices to fit their budget. This budget is something that would be compiled and maintained with the assistance of the Central Data Processing Warehouse. This will be done for all monetary transactions with categorical breakdowns on spending and projected cash flow requirements. The simulator excursion may have surprise rewards or Gateway Entrance Attractions to specific downloads or on-line stores, with special discount offerings or rewards by product suppliers for entering a store or mall as part of the shopping journey discovery experience;

T.) In alternative embodiments of the present invention, the Central Data Processing Warehouse may recommend prices to product supplier(s). The prices are based on the projected lowest acceptable cost to the consumer and lowest projected price at which the product supplier(s) will offer their products for sale;

U.) In another embodiment of the present invention, the Personal Computer Wallet contains a product reader. For example, some design suggestions may include a bar code reader, symbolic product package reader, wireless RFD tag reader, reader for any electromagnetic frequency emitter or symbolic product package code reader or a small wireless pen-like wand. This may allow the consumer to scan the products wherever they shop. Unit price or unit cost and cost comparisons with other point of sale merchants would be displayed. This allows for communication to the Central Data Processing Warehouse and those products (or secondary alternative products) are intended to be purchased in bulk. This allows the consumer to dedicate money for future purchases with consequential prices to be negotiated in bulk purchases for the consumer's preferred products by the Central Data Processing Warehouse or the consumer directly through the Master Catalogue. For example, consumers may scan a product in the store or check a product in the Internet Master Catalogue, for the Central Data Processing Warehouse, so the consumer's favorite items may be tracked for special offers and discounts.

V.) The product reader permits the Central Data Processing Warehouse to facilitate bulk buys since the consumer's choices become apparent. A confirmation of the product is displayed in the Personal Computer Wallet and proposed discounts are recommended. The consumer then picks the actual discount offer, the range of discounts they are willing to pay, or allows the Central Data Processing Warehouse to obtain the best discount deal without any prior approval required. For example, 10 items are selected for a 50% discount. The consumer is then informed either of an immediate acceptance or that the Central Data Processing Warehouse will hold their offer in abeyance to bulk with others. The offer in held in abeyance until an acceptance or a reply arrives and may inform the consumer of counter offers or alternate but similar products within their pre-specified price range. It should be noted that this step can be facilitated with a quick consumer verification of simple yes or no's to indicate acceptance or denial. The resulting charge will only be registered at the actual check-out.

W.) The consumer may pay to return a product, or the Central Data Processing Warehouse may implement a liberal return policy where a consumer decides they do not want a pre-specified product. For example, the Central Data Processing Warehouse may allow returns regardless of whether the product does or does not meet the standards set under the Uniform Commercial Code and its “perfect tender rule.” However, this return policy, with or without cost, can never reach the amount of total dedicated capital in the consumer pantry (making the consumer promise illusory). The return may ultimately reduce the consumer's cost savings of other pre-selected items in their pantry from total number of returns to the product supplier. “Consumer pantry” is an inclusive term, defined as anything in the Internet Master Catalogue actually purchased or optioned to be purchased or rain-checked to be bought. This may consist of multiple pantries or warehouses in multiple locations. Any return policy may be limited for luxury or durable goods or specific products. These options to buy or return a product, rain-checks, or coupons to purchase a product or service may or may not have monetary liquidity or transferability.

X.) In an alternative embodiment, the product supplier can determine bulk purchase discounts by pre-establishing the range of discount guidelines. The historical pool runs may aid in this measure. The product supplier can also determine the associated consumer participation levels, related to all real-time offers of the group pool, as an incentive. This would lead other consumers to make offers building a strike price for the pool once it swells or slows to its maximum desired or price discount capacity within a specified or reasonable time (all communicated via the Master Catalogue). Moreover, a prevailing market discount may be determined using a projected short term statistical analysis for that product for the bulk price value. This results in the creation of a standard discount formula based on recent past pool runs with periodic updates. This would occur once the product supplier has reached maximum production capacity, full cost of unit disclosure or we have a sufficient sample within a relevant and reliable sphere of members to determine this product cost equilibrium. This is more evident, when pool capture is operable among product supplier(s) themselves or in conjunction with input from the Central Data Processing Warehouse.

It should be noted that product cost equilibrium does not refer to the “equilibrium” economists define as the greatest number of employed workers producing products which are then completely consumed by the entire base of consumers. The term “Equilibrium” as it is used here is defined as a model of actual efficient production which consists of the lowest cost of producing a product, the lowest price for selling a product, and creating the maximum production and bulk consumer demand for that product.

Y.) In an alternative embodiment of the present invention, the product supplier may prevent the public from seeing all offers and thus make their own decisions on various price levels based on market forces. In the alternative, the product supplier may work with the Central Data Processing Warehouse in fixing the standard discount of prices based on overall pre-purchase demand or the real-time day-to-day flow of more immediate regional product consumer demand, regional availability and the consequent cost of supplying the products in a changing market. This method could be more effective if the product supplier disclosed the cost to produce each product or if it is coupled to real time demand. This method may involve an immediate communicative signal of competitive discounts to consumers displayed within the Master Catalogue. This may be done via a recognized graphic symbol or a spreadsheet comparison display from all the product suppliers, within the category or product type, wherein the consumer can choose their lowest price or preset this function to automatically scan through the Master Catalogue for this lowest price.

Z.) In another alternative embodiment, the product supplier may choose to stay within the pre-specified confirmed acceptance discount guidelines for the pool. In the alternative, they may choose to modify their offer with a lower price structure for the pool of consumers with the goal of achieving a strike price for the consumer pool or securing the pool against possible capture by another product supplier. This may occur when a product pool is open for capture, as determined either by the product supplier or by the Consumer Data Processing Warehouse. The Consumer Data Processing Warehouse may capture pools on behalf of the offering party itself in a more automated mode for exclusive or already highly discounted products or based on a specific objective formula that does not favor one product supplier over another or product supplier over consumer. This specific objective formula is related to the data management side of consumer offers, within the criteria described, once the statistical models have been run. The models should predict that some pools of desirable brands have dedicated consumers who may have a longer pool stay once a pool has been captured in part and wait for new dedicated consumers to come on board to achieve the maximum discount. This method may be used to begin anchoring new brands with special offers or establishing brand preference dominance based on the increased value for the consumers and not merely the brand names and advertising. Therefore, a mechanism for pool time dedication can be allocated by the consumer, the product supplier, or both to serve the purpose of achieving the lowest discount for the consumer and the highest sales for the product supplier. Dedicated consumers may create profit by cornering the market once they buy out all of the available product once maximum production capacity has been reached. It should also be noted that all products have the potential for resale between consumers. The artificiality of market force distortion related to the artificially inflated demand for personal consumer profit can be checked when a simple transfer to the pantry is accomplished electronically. Transfers may be limited based on each person, product order, and time frame so other consumers are not disadvantaged in realizing price discounts in times of short supply;

AA.) The product supplier may offer options to buy at a certain price or rain checks to purchase that are set to expire at a specific time;

BB.) In the alternative, the Central Data Processing Warehouse may replace the function of the Product Suppliers having pre-negotiated levels of discounts or allowing the computer to select prices and availability in an automatic preprogrammed competitive interactive environment. This environment locks in the lowest available prices for the consumer in real time, builds their pantry, and creates their shopping list for future purchases or pre-bought pick-up. The prices on these lists may vary, however, they can only decrease to benefit the consumer with savings. This competitive interactive environment includes a history of past pool runs, real time trends and employs the best discount method to achieve the lowest strike price or bulk purchase price, as an pre-set automated function by the Central Data Processing Warehouse for the consumer. There are subsequent verifications or acceptances by the consumer that range from simple acceptance at check-out or through more intensely edited consumer choices. All cost savings methods may also be graphically displayed in the Master Catalogue with an interactive running tally of potential cost savings or the increase in the value of options to buy, rain checks, redeemable coupons or special rewards when comparing the price paid by the consumer to the current market value of those options;

CC.) In the alternative, the consumer may fund specific brands for multiple purchases such as food items or drugs. This establishes brand loyalty and a pre-set individual discount depending upon the number of pre-set purchases the consumer pays for in advance or promises to pay for if picked up within a specified time period;

DD.) In the alternative, the consumer may purchase bulk products without reference to brand. This may include various brands within a category of products or generically manufactured products which allows for a consumer discount due to the selection of multiple purchases at the same time;

EE.) There may be a display of a time limit in which the consumer may pick up the products or the fixing of a reasonable end time frame for the pick up;

FF.) There may be a display of the available units within the stocked pantry of the consumer as contained in their personalized Master Catalogue;

GG.) There may be a display of a per unit discount based on a gradient of lower prices. The greater the number of units pre-purchased by the consumer, the greater the discount;

HH.) In the alternative, the consumer may pre-dedicate a specific amount of funds or funds for options to purchase, for their future pre-selected purchases or specific number(s) of units desired to acquire, without prepay but by pre-select and *promise to pick up and pay, and then allowing the Central Data Processing Warehouse to leverage their choices with other consumers into bulk purchases or pools to drive prices lower. This type of promise may simply include a secured promise without an immediate payment by the consumer. Rather, this promise may create a creditor status for the product suppliers directly or may be monetary credit such as through a credit card. Such a consumer promise described herein can be interchangeable through all claims. The consumer promise is the consumer's promise to pick up and pay which makes the actual exchange a real promise having legal detriment. Moreover, if the consumer decides not to pick up the item, then they may suffer a penalty up to or equal to the amount owed. However, the product supplier may be under a consequential duty to mitigate their damages by attempting to cure the default by offering to resell the un-bought product in the marketplace. For example, the product supplier may offer the product in the Master Catalogue while the consumer may remain responsible for off sets such as storage fees and any sale price reductions;

II.) The consumer continues to enhance their consumer profile for the items they target as regular buys. The consumer achieves this by completing a detailed on-line survey which includes detailed personal, demographic, and categorical information for their target product selections and alternate picks within the same class or category. In addition, there is ongoing data mining of actual purchases, Master Catalogue consumer views, and the product supplier's tracking of consumer views, general Internet or in-store visits/views, or remote sensor recognition. This step may include a human Origin Code product advisor doing a one on one or group tutorial advisement of shopping finance through the Master Catalogue or through a simulator tutorial tailored to the individual consumer, product supplier or standard public informational excursion display;

JJ.) In the alternative the Central Data Processing Warehouse may display a specific or generalized circular to the consumer within their personalized Master Catalogue. The circular is activated with the consumer's Origin Code and is related to the specific task of multiple purchases by walk through, of methods available in the Master Catalogue or as recommended by product suppliers or Central Data Processing Warehouse. Personalization means to follow and know the consumer's buying habits and product interests as well as the product supplier's production and customers;

KK.) The consumer selects items to go into their shopping list for purchase and pick up;

LL.) In the alternative, the consumer may choose certain products to be scanned in a generic category where the Central Data Processing Warehouse will automatically seek the lowest price for the product and sort the shopping list of actual purchases for the consumer. The purchases are then achieved at the maximum discount for all consumers within the system who have designated this automatic feature and dedicated the specified level of prepay for the task. The real time point of sale purchases may be able to piggyback specific products for the same or similar discounts depending upon the store, product supplier, the dedication of the consumer to the product or store, and the on site system method for processing the real time transaction as linked to the Master Catalogue (when the combined spending power of all consumers would be important for determining the statistical discount methods);

MM.) In the alternative the consumer may send a signal through the Master Catalogue to join an impulse purchase network which is defined as consumers who have an immediate product desire or need. For example, a consumer may have an immediate need for a coat or winter heating fuel. The Origin Code will provide the regional and demographic data information for the impulse group and product suppliers as well as a systemic generated alert within the Master Catalogue for the impulse products with sorted price and demographic guidelines of product price offers, product price solicitations, and availability;

NN.) These categorical data offers are dispersed to product suppliers who may send offer data back to the Master Catalogue to fill the group consumer needs with specific products. The information in the catalogue displays the number of available product units at the point of sale for the product and the price;

OO.) Consumers may then decide which offer they will accept through the Master Catalogue or choose to leave the negotiation of price to the Central Data Processing Warehouse for a concluding price once they have selected their product;

PP.) A record may be established for the consumer who is a dedicated brand purchaser and it may be filtered through pre-specified product suppliers or the data card holder's guideline. This is done in order to establish the consumer's status as a “dedicated consumer” for a specific product supplier and is based on the history of purchases and anticipated purchases. This is also directly related to the consumer's projected product requirements rate for a reasonable or given time frame;

QQ.) A record of the consumer's purchases and the consumption rate is maintained in order to indicate the time period for repurchasing or restocking their pantry and achieving a lower price for the consumer as time progresses and they continue to use the products. This is why archiving data associated with their purchases for a long period of time is necessary and should not be considered an unnecessary intrusion on privacy;

This feature would be helpful to older and publicly assisted consumers who have less income but are dedicated to a particular product over a long period of time. For example, the government may determine the presence of a long term symbiotic relationship between reliable product suppliers and publicly assisted consumers for products necessary for elderly care or infant nutrition. This may benefit fiscally challenged social services and persons with limited incomes.

RR.) Allowing the product supplier to directly fix the discount percentage in the Master Catalogue based on special seasonal promotions such as holidays, year end sales and back to school sales. Other discounts may be applied to overstocked inventory, liquidation, consumer to consumer exchanges, trades, and bartering for undesired, non-refundable or less affordable items;

SS.) Establishing guidelines for upcoming close outs, liquidations, and special promotional sales through the Internet Master Catalogue based on the overall attraction of confirmed offers coming in through the catalogue promotional section or the section of the Master Catalogue entitled “Specials;”

TT.) Fixing a percentage of discounts based on a threshold of orders. For example, the more orders received, the lower the discount for the group;

UU.) Establishing a time frame for the discount offer based on posting the current number of available units and those sold;

VV.) In the alternative, fixing a discount for all customers based on a time frame for the purchase;

WW.) In the alternative, allowing consumers to combine their purchasing power into a group for a discount in the methods previously described or for gift cards in a store-by-store basis. In this example, the term “gift-card” is not limited to a specific plastic card. Rather, a “gift-card” may also be data linked to an Origin Code, or transferred to an another gifted Origin Code or credit card account having monetary potential;

XX.) In the alternative, allowing for the pooling of stores into a generic discount store card. This may consist of many stores, warehouse or product suppliers which allow consumers to combine their purchasing power into a group by any of the discount methods already described;

YY.) In the alternative, a section in the Master Catalogue for new brand introduction giveaways and free items. This may be allowed as an unrestricted offer to first time users or for individuals with keys (embedded numbered data codes) for the Origin Code given away to particular people to open pages in the Master Catalogue. These individuals may include those who have demonstrated product interest through past sales, catalogue views or data mining. The keys may also be given away through a special rewards category linked to the consumer's acquired points and redeemable according to the pre-specified value of points.

In one embodiment of the present invention there is predictive consumption modeling on the universe of products purchased and used by the multiple Origin Code consumers. This modeling is achieved through combined regional and global statistical analysis of predictive product consumption rates for the purpose of combining a consortium of product suppliers and making offers to consumers as groups. Separate pools are maintained but they may be sorted into larger generic product categories or combined together as a larger group pool. This is known as a single generic pool. In a larger single pool, all parties agree to the same starting price or starting price range and allow coordinated action until the suppliers drop away or come on board with the lowest discount cost of products from product suppliers remaining or wherein all discount costs are shared equally, for participating brands, in order to achieve price equilibrium. The price equilibrium is defined as the lowest competitive group prices for each category and unit of the same product type. This magnifies the overall frequency of discounts or lowest discounts and merges with the programs of the Central Data Processing Warehouse for the methods previously described. This would be especially effective when the consumers are guided into choosing alternate brands within the same category for pre-dedicated money. There are two types of consortiums. The first consortium is by design where a computer program automatically combines product suppliers into categories of products produced. The second consortium is by volition which is formed in conjunction with the product suppliers themselves (which may include the product supplier's computer programming input) or with all parties involvement (which may include the product suppliers, the Central Data Processing Warehouse or the consumers. Many of the assisted downloads or computer programming links from product suppliers, consisting of their product information, offers, counter offers, and discount methodology requirements will have its origin from the product suppliers themselves in many of the claims throughout. Alternatively, many of the discount method commands will come from the Central Data Processing Warehouse itself due to quality control and because they will harbor the largest supply of data for all parties concerned in the Master Catalogue.

The predictive consumption modeling may include the following steps:

A.) A business method computer program analyzing numerical statistical data of product cost production, storage costs, delivery costs to the point of sale and the associated minimum base profit requirements per unit of sale in bulk;

B.) Advising product suppliers of the statistical rate of anticipated purchases for their products and the profit advantages of entry into the consortium;

C.) Advising consumers on pre-production prices for their future bulk purchases and estimating the average anticipated prices for the dedicated pre-paid products within the generic or general product category or those prices projected for specific brands within the consortium;

D.) The projected statistical consumption information provided to product suppliers is then used for enhancing competitive differentiation and pre-production investment advisement by consumers. For example, this advisement can take the form of directing consumer's prepay into the strongest competitive discount companies, the most reliable suppliers, directing the remainder of their prepay allocation dollars that has not yet been finally designated because of exchanges, returns, rejections, failed pools or rejected offers, or simply combining discount reduction savings on pre-dedicated capital. This investment advisory function may take many plastic forms and graphic numeric displays demonstrating the exaggerated effect of all consumers buying one type of product or not buying another. Any direct investment advisory function from the consumer prepay may take the form of implied consumer consent and verification. The direct investment advisory function is defined as taking all the information related to the consumer's purchasing habits, such as data mining and actual or anticipated purchases, and then sorting those monies into product supplier investments (as prepay investment money). Then they seek confirmation from consumers for their prepay monies to product suppliers on the Central Data Supply Warehouse picks, Next, they sort those monies from multiple consumers into bails, make the bulk allocations of properly designated capital to indicated product suppliers, and maintain the data of where the benefit to the consumer flows. A buy confirmation may be a one time event, initialized at the point of an initial consumer product survey of anticipated product purchases or a one time confirmation event, and going forward, for each such type of purchases for the consumer pantry. A promise to pay and pick up need only be supported by nominal consideration which is a legal term defined as any dollar amount of legal detriment. This allows a consumer with limited income to stock their pantry with multiple items at one time when they can only afford to pay under a weekly limited budget or have it automatically renewed as a consumer requirements contract;

E.) In the early stages of equilibrium, all pools open freely without lock-down. The pools are free and only guided by natural market forces;

F.) The Central Data Processing Warehouse then captures the lowest usable price pools and disperses those products to fill pre-dedicated capital orders;

G.) Pools are declared open by all product suppliers as a requirement for entry into the consortium;

H.) Alternatively pools are declared locked down, in whole or part, by product suppliers or the Central Data Supply Warehouse with possible advice and consent by the Central Data Processing Warehouse;

I.) Alternatively pools are opaque to all but the Central Data Supply Warehouse so product suppliers are unable to see the prices of competitors or only two or several pools are revealed to one another for purposes of competition. This is done when it is discerned that blind competition would enhance consumer discounts. However, it would be highly improbable that all offers from consumers or product suppliers would be opaque throughout the Master Catalogue. Openness would generally be operational for product supplier categories unless the models demonstrate that uncertainty insures lower initial prices for individual bulk buys or consequential final strike prices for pools. If there was an entire or large segment opaque black out of data on offers from other competitive product supply pools, then this could be for purposes of objective sampling analysis, price competition efficiency. This requires modeling to determine where and when it will be effective. It may be a protracted period to determine if the final numbers are real or artificial sacrificial discounts from product suppliers seeking to undercut competition in order to keep them out of the consortium;

J.) Implementing computer firewalls, virus detection programs, and encryption of data dispersals will afford a higher level of security for this objective of controlling secure data for all parties concerned.

K.) Implementing a threshold requirement agreement that product suppliers must not seek to acquire any product price information on competing product prices during the time of a competitive price blackout or other specified time of price auditing for fair competitive compliance. This includes seeking information through consumers either directly or indirectly and through other methods.

L.) As an alternative added step, all data related to specific prices paid by the consumer at the point of sale or in bulk prepay are blocked from view to prevent analytical collection. Specifically, the prices paid for specific items are not posted for the consumer except as a total of the amount of all sales purchased. This may be problematic for the consumer unless this is specified as a threshold requirement for Origin Code participation, especially for periods during a price standoff between groups of consumers and product suppliers. Consumers want to know what they are spending money on. Instead of a detailed list of prices, consumers can obtain an electronic or paper receipt of the total amount due or spent and some general (single FIGURE) price comparison featuring in-store prices versus overall savings for all items purchased. As purchasing only one item would defeat the purpose of preventing product suppliers from being able to draw inferences, there may have to be a threshold requirement for the consumer to achieve the objective of true opaqueness. For example, there may be a minimum of 10 items at check out or on a receipt. However, the required number of items required to be purchased at any one time to defeat any product price inference that can be drawn by the product supplier for any specific product price remains to be modeled. An even higher level of security for this subsection step may require prepay funding with credit or debit information. This is related to amounts paid that are now held in abeyance with only some type of simplistic warning that “your funds/credit are low” and random replenishment from a larger secondary previously funded source. This may allow, for example, a direct quarterly accounting to the consumer displayed directly through the personal computer wallet or Master Catalogue or bank account or credit card statement. The consumer may also have access to a product advisor for clarification of purchases.

M.) In the alternative, decryption auditors may regularly be used to advise consumers and product suppliers of important related product price data for purchases and large brand items on a safe, need to know basis.

N.) In the alternative, all actual product supplier prices are displayed in a time lag after a sufficient forward looking price position has been locked in for the consumer. This may be the case with the goal that consumer offers are being accepted so that consumer pantries become sufficiently stocked.

O.) Alternatively, all pool information is notoriously posted to most or all parties through the Master Catalogue;

P.) Statistical analysis is processed to determine if pool formation is actually static at or near a strike price because the product suppliers have realized actual bottom or a false bottom. The “actual bottom” is defined as the actual lowest cost they can sell their product at. A “false bottom” is defined as the best price at which product suppliers can sell their product, within the universe of pools, because they have fixed prices among pool participants by either pacing one another into an incrementally slow decline until competition falls off or starting either the pool formation or price levels high and remaining high. Small percentage price differentials may have no effect on consumer selections when consumers have brand preferences. This raises the possibility that static brands would lose business because they only beat the competition by a small margin. By pre-selecting alternative choices besides first picks, it may help insure driving the overall discount prices lower if alternative competitor's choices are revealed to product suppliers when large bulk buys are operable. If the statistical analysis determines that this false bottom exists, or if the competitive system is running slow based on other objectively inferred indicators, then going opaque, for an appropriate period of time. Opaque is defined as the blackening out of offer data and acceptances from competitive product suppliers. However, there may be limited exposure of the competition's new lows to drive additional discounts or communicating to the product suppliers the discounts that would generate an alert to consumers to participate in their pool. Allowing the Central Data Processing Warehouse to facilitate pool capture may be the penalty imposed on pool participants who try to fix or pace competitive prices. This is not punishment or preferential product supplier treatment as the Master Catalogue competitiveness is run by objective criteria. This does not favor one product supplier over another or one consumer over another in the bulk buy methods the computer programs or human interveners employ. Instead, this operates in the consumer's best dollar value interest and the primary goal is to maintain consumer credibility. The models may prove in early stage development that automated pool capture by the Central Data Processing Warehouse, and having the pool system opaque, except to the product supplier themselves, is related to only the offer and final consumer acceptance. This could be the best method for achieving consumer discounts consumer and any auditing of the processes of the Central Data Processing Warehouse by product suppliers themselves may be prohibited.

Q.) In the alternative, consumer offers may be held in abeyance or regulated for purposes of product supplier negotiations. This holding of multiple bulk offers is referred to as “sorting and bailing.” Specific offers are sorted into product category offers and then bailed together for the maximum discount impact. This leaves these consumer offers open to capture by product suppliers or the Central Data Supply Warehouse which can take an active role in product steering. Product steering is accomplished by suggesting specific offers, from product suppliers who have a strong history of discounting their goods, to consumers. In the alternative, the Central Data Supply Warehouse can negotiate automatically by gaining the consent or implied right of consent through the prepay “buy for me” function which does not required the consumer's review. The Central Data Supply Warehouse then discounts the consumer offers from product suppliers by a planned, projected or automatic percentile discount, as more offers are released with lower prices. This is not a boycott to some producers that is meant to harm or punish product suppliers negatively effected by this approach. This is evidenced, in part, with the axiom of the system model; the greater the number of product suppliers, the greater the overall competitive health of the system. Rather, this is capitalist system where product acceptance steering reinforces indications of historically inclining lower prices and rewards efficient product supplier's cost efficient production;

R.) Alternatively, individual pools may deepen when members of the consortium subcontract out production within brand categories to other product suppliers or merge brand production power for a better average bulk purchase price and receipt of larger orders. However, this only applies if the models of past history runs, for example, do not show a false bottom from lessened competition;

S.) In the alternative, product suppliers can offer guaranteed prices by virtue of any of the methods described herein, especially in consumer prepay. This allows for problems associated with economic recession, inflation, and resource scarcity. Although not a technical specification, this step may work to benefit the product producer worker. This would allow for a minimum guaranteed hourly wage for low paid workers which would prevent exploitive labor in a globalizing economy. This is important for regulating developing economies and creating humane working conditions.

T.) In the alternative, each pool within the product category is combined with multiple pools and captured by categorical acceptance of product supplier offers. However, only the average price of products purchased is tallied for each participant consumer as a cost to the consumer who equally shares in the price discount equilibrium for some given or reasonable period of time. This equal sharing of product costs can be for individual or multiple products over an extended period of time;

U.) In the alternative, consumers may share product supplier pools according to some other reasonable criteria as opposed to being shared equally. Examples may include sharing according to the amount of capital dedicated for prepay (the higher the amount of dedicated capital, the larger the overall discount realized by the consumer), by a willingness of the consumer to pay a carrying charge fee (the actual cost associated with procurement measures of the Central Data Processing Warehouse such as the cost of added negotiations, processing, and subsequent verification by the consumer to the Central Data Processing Warehouse of early pool capture or price acceptability, a fee surcharge (such as a predictive analysis geared to the consumer's purchase), or a carrying charge fee charged in association with the overall specialized work on any claims method described. Consumers may share in different discount proportions. For example, an individual or business that has opted into a collective of multiple buyers for added bargaining leverage or an individual with a high rate of consumption may receive different discount proportions based on their demonstration of high volume buys or their willingness to consume higher amounts of products. Sub-collectives within the system may be prohibited if the models prove or suggest that they disadvantage the spherical census of Origin Codes in the system's fluidity. This disadvantage may occur where the favored incentive discounts are eliminated for early pool capture due to product suppliers relying on a small profit margin because they are confident of sales to a break even point where they can still overcharge consumers;

V.) The lowest current price information for generic products is displayed to the consumer, for pre-production product investment, or the pre-dedication of capital resources for the consumer pantry;

W.) Alternatively, a percentile discount is set by the product supplier for the Origin Code in the Master Catalogue for pure consumer to product supplier investment. Pure consumer to product supplier investments occur when the consumer allocates money for investment in the business entity of the product supplier itself at pre-specified amounts. This results in product discounts across the spectrum of brands, the company, or the product supplier's market as the consumer has now declared themselves a dedicated consumer. Under this method, the consumer is basically investing in the future success of the product suppliers in exchange for a discount today and in the future. This is an investment method that can be established by each brand name product supplier individually with a return on product discounts;

X.) Combining established pools within the consortium or by the other claims previously described. The combining of established pools may be either through specific brands or multiple brands which results in a generic product category of brands or products which allow for a shared profit incentive for participating product suppliers when the competition is cooperative towards the goal of benefiting the consumer and there are objective criteria in place to determine fairness such as past pool price runs. The purpose of the combined established pools is to establish the same per unit or dollar measure discount price for products within that generic category. The term discounts can have broader implied meanings with a limited universe of products or a single large market share of products processed through the Master Catalogue. For example, with fewer products available for comparison with prices, products may not be discounted unless the discounts are by an industry standard of profit versus cost of production. The verification of a discount is possible even if there has only been one individual item for sale and there is a market product price history of one other being sold. This is why the Central Data Processing Warehouse must strive for obtaining as much pricing information as possible and process that data to reflect and achieve this demand discount symbiosis between consumers and product suppliers.

Y.) The consumer is allowed to shift between product brands within a category and not lose their discount as a requirement of entry into the category. For example, everything is the same percentile discount or the same discount price;

Z. In the alternative to starting with a category of discount priced products that are fixed and similar, but differentiated by brand, so that if a consumer pre-specifies a large order, for a preferred product brand; they have their buy order realized, and this determination would come through statistical product advisement to consumers or producers or Central Data Processing Warehouse negotiations or be automatically pre-set by the Central Data Processing Warehouse; once they have advised the product supplier on the best method of discount; to attract the largest number of buyers or to obtain the largest discounts for the largest numbers of buyers; [It should be noted that this advisement function to product suppliers, on their downloads into the Master Catalogue, is a critical function to facilitate the management, of large amounts of data, related to product supplier categories and individual products within those categories. For reasons of expediency the Central Data Processing Warehouse advisories can be mandated to be followed by product suppliers through: the convention of past experience. Alternatively, there may be voluntary advisories that are made a part of product offerings or directed in whole or part by the product suppliers themselves. Statistical analysis will also play a key advisory function to product suppliers and consumers on product supply, prepay, past and future consumption projections, feedback, and varied monetary demands from preproduction to the final product delivery. This analysis will include general economic indicators, specific Origin Code data, and product supplier's enterprise data.

AA.) Shopping lists may be pre-sorted for the consumer with a list of products awaiting pick up, a list containing information related to brand and unit price levels, the consumer's anticipated rate of consumption for each of their brands, or advice from the Central Data Processing Warehouse to the product supplier who is part of the consortium;

BB.) In the alternative, the predictive statistical data is distributed to individual product suppliers as a generic offer for the anticipated rates of consumer product consumption. This also includes the associated individual price discounts that may realistically be projected with pre-dedication of consumer capital into their individual products or total bulk spending to the company. If these numbered parameters are pre-set, then the system runs automatically with the consumer or product supplier's offer, the consumer or product supplier's immediate acceptance, and the Central Data Processing Warehouse processing of all transactions. Real time opt-ins, such as customers at checkout or real time business transactions, can also be factored into the statistical analysis of projected product consumption rates or actual acceptances without the consumer having to have gone through data mining or surveys or any consumption analysis. Instead, the consumers may have simply opted into the data processing mechanisms of the Central Data Processing Warehouse. The data processing mechanisms may include globally positioned computer adjuncts of lesser storage and processing capacity meant to handle local consumer traffic or any computer processing remotely that is part of the entire data processing infrastructure.

Another feature of certain embodiments of the present invention is the creation of an exclusive club membership linked to the Master Catalogue which comprises demographic statistical data of the individual within the context of regional demographic analysis and leveraging discounts based on the preferred and higher level buying status of the consumer.

While income would tend to be the primary method of calculating the exclusive membership, this preferred status may also be determined by consumer dedication to a specific product brand or associated product brands. This has the effect of making any Origin Code a brand type enthusiast eligible for this specific type of preferred status. Such membership would not only be limited to, for example, connoisseur products or sub-cultural products. Membership may be based on broader categories such as newlyweds, exclusive brand discounts for luxury items, luxury brand names or durable goods. One of the most important criteria for this status within this exclusive group would be the amount of money the individual consumer is willing to allocate to prepay. A high allocation of money to prepay is critical to servicing a well financed or educated consumer and they may be rewarded for it.

It should also be noted that this type of exclusive club may work well where specific brands are resistant to bulk buys but their competitive brands are willing to participate in order to obtain a greater share of the market. For example, consumers may be allowed to cancel their previous order for a new model car when it was an order placed for a competitor's car. Even if the consumer suffers the penalty of losing their down payment, the alternate manufacturer will gain a new customer and thereby achieve the lowest strike price for this year's annual model for any pool run.

In a further embodiment, a store or regional physical warehouse is linked to orders coming in through the Master Catalogue. This warehouse stocks products which have already been ordered in bulk and is fully automated for rapid product sorting, packaging, quick pick up by consumers, and direct delivery to the consumer. This consists of the following steps:

A.) Bulk orders are received through the Master Catalogue;

B.) The consumer alerts the product suppliers and warehouse through the Personal Computer Wallet or Master Catalogue that they will be picking up their specified products that were pre-paid or sorted in their shopping list;

C.) In the alternative, the consumer picks up their products based on an alert from their pre-sorted shopping list, through the Master Catalogue, or more particularly and probably their Personal Computer Wallet. The consumer may also simply request that their shopping list be automatically sorted for items needed and the approximate time in which they will be ready for pick up;

D.) In the alternative, the supply warehouse designates a window of time in which the consumer or product transporter is to pick up the product which will be ready and waiting at checkout;

E.) In the alternative, the consumer communicates with the kiosk at the store or regional warehouse for the products they want to pick up immediately. An example of this kiosk may include a towering visual display such as a giant high definition video screen robot or a small personable robot that walks the consumer down real or virtual isles and interacts with the consumer. This kiosk may provide information on special warehouse liquidations, closeouts, promotions, sales, seasonal, holiday advertising, or emphasize the automated quality of the store or warehouse and the user friendly nature of the automated system.

F.) In the alternative, the consumer is able to move through the shelves of the store or warehouse and physically inspect the products either by walking or being conveyed by a rapid sidewalk or seated people moving conveyor system they can make stop, go, rise, and go down;

G.) The consumer's choices are selected and linked to their Origin Code;

H.) The consumer's choices are then automatically presorted by machine, conveyor belts, human pickers, by the consumer picking and placing selected items into a basket or bin that move to a point of packaging or check out, or some combination of these methods;

I.) In the alternative, the consumer's choices are picked up by human operators who are seated on electric movable dollies that also function with lift capacity, allowing them to cherry pick from the shelves in all directions. The operators may then fill the consumer's basket with pre-selected pre-paid goods;

J.) The consumer's entire purchase is then routed to a packaging/bagging area;

K.) Then the consumer picks up the packages in person at the store or warehouse facility;

L.) In the alternative, the consumer's packages are then picked up by the consumer and placed in their motorized vehicle trunk or container as they pass their motorized vehicle through a drive through;

M.) In the alternative, the consumer's or business' packages are delivered directly to the consumer's house or business address.

In a further embodiment of the present invention, the system allows consumer or product suppliers to build their own autonomous consumer to consumer alliances against product suppliers, within the Internet Master Catalogue. These alliances may be formed as teams within product categories or overall teams for all purchases within the Master Catalogue. This may consist of the following steps:

A.) Posting invitations to attract team members for consumer pools;

B.) In early team formation, one trusted team leader is selected as a gatekeeper along with multiple possible subordinates who also act as secondary gatekeepers or task assistants. The purpose of the gatekeepers is to facilitate information exchanges and data dispersals on designated product targets;

C.) The team leader takes and examines pool feedback by email or a secure catalogue posting and communicates to members through private email (public or secure) or posting within the Master Catalogue;

D.) In the alternative, product suppliers or the Central Data Processing Warehouse similarly communicates with the team leader and consumer pool to aid and advise so as to maximize discounts;

E.) The team leader disperses requests of incoming data on offers from product suppliers for various products within a category which were pre-sorted according to category, specific products, and price levels. The offers and counter offers flow back and forth with the designed purpose of achieving discounts for the consumers. This may be an automated step process with data dispersals by the team leader being sent directly to the Central Data Processing Warehouse or as pre set via an automatic programmed function within the Master Catalogue which does not require a team leader. It may also be sent by the consumer group's interactive command or automatically for the one Origin Code along-side a facilitator (an automated, interactive discount computer program:) graphically exhibiting accrued savings in the Master Catalogue or personal computer wallet;

F.) The team leader has incoming data on offers from product suppliers, recommendations for pool price offers, and projected parameters or potential discounts from the Central Data Processing Warehouse;

G.) The team leader formulates his own relevant voting questions for pool consumers either through verbal questions, pre-set ballots, or receives voting suggestions from product suppliers or the Central Data Processing Warehouse. These ballot form votes allow for the pre-sorting of relevant data (primarily on offers) into usable categories for later data dispersal to product suppliers, ballots from product suppliers, consumers, offers, counter offers, acceptances or rejections;

H.) Consumer votes take place in a series of rounds that are automatically sorted for confirmed targeted dispersals. The votes embody specific questions related to the price, product, and offer;

I.) The gatekeeper sends timed warnings to either consumers or product suppliers readying the data dispersals of team members. The timed alert warning to consumers of a soon to close pool, for example, can be through any electronic communicative devices;

J.) The gatekeeper releases offers upon targets;

K.) The system registers any counteroffers and then cycles offers and acceptances directly to consumers and product suppliers which may recycle until there is a strike price for the pools or individual bulk buys. As the time limit for pools are about to come to an end, an alert may go out to consumers who have expressed or who have a potential product interest in the pool. These alert features in the form of a graphic interface within the personal computer wallet or Master Catalogue may be sorted or highlighted, for those groups of pools within the Master Catalogue or for those products coming close to a strike price. In addition, gatekeepers may initiate alerts on pool formation, lock down of pools, or free floating prices, which have achieved pool or brand price equilibrium (the lowest anticipated price or final offer);

L.) In the counter offer stage or pre-acceptance stage there is a team leader. In all embodiments, the Central Data Processing Warehouse can regroup the pools before acceptances (in whole or part) for a stand off on price against product suppliers. The pool may then be opened to other product suppliers who may counter offer to any open pool and capture the pool (in whole or in part) with an approved consumer pool acceptance (in whole or in part);

M.) In the alternative, the entire event is a public event or broadcast event conducted within a closed or open space such as a stadium. The gatekeeper, a personality who inspires people to join the product pool and recognized master of product pool regulation, may be present. This may be important for certain items such as luxury brand name products and new model cars;

N.) In the alternative, offers and acceptances are accepted individually, within groups, and based on free-floating in-house guidelines of the product suppliers;

O.) In the alternative, the entire system of actual purchases bypasses this critical acceptance step in the Master Catalogue of actual acceptances of offers. Discounts are realized at the point of sale merchant upon consumer and merchant's purchase or acceptance regardless of any actual consumer data card membership. This allows the Central Data Processing Warehouse to capture a greater volume of real time sales and overall consequential discounts. However, this only applies where the merchant or store allows the Central Data Processing Warehouse to set up pool capture or efficient price discounting for all its customers;

Product supplier and merchant store are interchangeable terms and all the specifications described herein are applicable to all products suppliers as under the umbrella of any merchant store. This applies especially to large chain department stores which may find it desirable to participate in automated discounting for it's consumers.

P.) In the alternative, the entire data processing system is automatic which does not require a team leader or the Central Data Processing Warehouse controlling discount methods. Instead, the data processing system automatically cycles through product categories for the individual Origin Code and cycles through associated public solicitations and gathers consumer offers. All data dispersals on offers and acceptances are then automatically pre-set for appropriate exchanges of offers and acceptances. As time proceeds, computer decision making is based on an historical analysis with the goal of maximizing discount potential based on past transactions between consumer, product suppliers, and merchants. Consequential future transaction projections are derived or inferred and this information is then used to achieve maximum discounts for the consumers and maximum sales for the product suppliers. This is done in a more wide open flexible system where three party's concerns are more balanced. First the consumers, second the product suppliers, and last the Central Data Processing Warehouse;

Q.) In the alternative, no Master Catalogue is required for all previously stated claims. The Central Data Processing Warehouse accomplishes discount methodologies for consumer data credit or debit card holding members and personal computer wallet members by having consumers create a shopping list of the things they will buy or automatically creating a shopping list based on past purchases, confirmed anticipated purchases, or data mining. This is followed by the segregation of their dedicated money for their future purchases. All discounts are registered automatically at the point of sale merchant as achieved by the Central Data Processing Warehouse which acts as a liaison to product suppliers and responds to either pre-programmed percentile standards or the standards set by the interrelated claims in all specifications previously discussed;

R.) A preset notification system to participants may be enabled. This sends an email, Master Catalogue Alert, or some other form of a recognized alert signal to consumers or product suppliers when an offer is accepted. Different alert signals may be sent when an offer has been countered, a new pool is opened or about to close, a pool is declared “open to potential capture,” or a pool is automatically presented for potential capture by another product supplier who has a comparable product to offer and would like a showdown on price (and a consequent opening offer has come in from that product supplier to capture the pool with a better counter offer). This process of moving from pool to pool may be pre-set by the consumer or the Central Data Processing Warehouse to the automatic lowest price formulary;

S.) More specifically, to characterize all previous interrelated claims, the business system methodology may be accessed without a consumer data credit card, common credit card, or debit card. However, it may be accessed simply by oral agreement or an implied-at-law agreement. For example, it may be accessed by simply showing up at the check-out cash register that processes Origin Code transactions and is designated or labeled for all transactions. It may also be accessed by prepaying through any cash transaction at an appropriate period of time before purchase. This can be facilitated at an in-store kiosk, for example, and confirmed at the same kiosk before checking out. Flexible changes may also be made in-store for items that are not priced within an agreeable consumer or product supplier limit;

T.) More specifically, the Master Catalogue may display gains realized by the consumer or product suppliers in foreign transactions (through monetary exchange rates) through the Central Data Processing Warehouse. They may also capture a fee for transacting international monetary exchanges of those purchased products at any point in real time or can display savings related to actual stocked pantry items in prepay when compared to the actual market price of the items;

U.) As a promotional methodology, the entire system method described through the Master Catalogue may take the form of pay or public access via a live or programmed television cable or satellite interactive broadcast. It may also be available on the Personal Computer Wallet, an interactive world wide web television linked to the Master Catalogue, through a public event, in-store event, out of store event, promotional display or kiosk that links consumers or product suppliers by virtual shopping simulations previously described in the related claims.

In another embodiment of the present invention, the consumer/Origin Code designates those items in the personal computer wallet that the consumer regularly buys asking the system to get them the lowest price the program can achieve using any of the methods mentioned. Choices are made by the Origin Code through the Master Catalogue, and the Origin Code designates an automatic price selection(s) allowing the Central Data Processing Warehouse itself to choose the lowest price item or lowest price, per unit, priced item in a pre-programmed manner. The steps of this embodiment may include:

A.) Gathering product data from the product suppliers specifically related to product type, product cost, product volume, product availability or delivery time;

B.) Utilizing the claims and business methods previously described to choose the lowest price to pre-purchase or real time purchase as it best suits the needs of the consumer's designated or projected consumption requirements;

C.) Downloading projected or automated purchases into the Master Catalogue;

D.) Providing the consumer or business with detailed and regular reports of items in their pantry and information related to the projected cost requirements of their standard of living for the products they consume;

E.) Allowing the consumer or business an opportunity to edit product, choices linked to their Origin Code to fit their budget before they pre-dedicate capital;

F.) Amassing the overall data as received from Origin Codes to negotiate through the claims and steps previously described to obtain lower automated discount prices;

G.) The Central Data Processing Warehouse completing all transactions and assessing associated fees with all transactions through the Master Catalogue. This includes surcharges for added advisory services.

In a further embodiment, the Origin Code (via the Internet Master Catalogue), will permit the consumer to choose among numerous credit card products to achieve immediate balance transfers or combine their credit purchasing power into one mass of multiple cards or multiple consumers within the pool. This allows those with poor credit more ease in achieving higher levels of approved credit as less consideration is given for their credit based on their past or anticipated indicated product requirements. This will make it possible for those with poor credit to receive the lowest available interest rates for their purchases. In the alternative, instead of an interest rate, the group may pay the bank a fee.) The secure data for informational displays does not need to be sent through the Internet for all transactions. For enhanced security or cost efficiency, the secure data may be transmitted through other electronic means and methods. For example, enhanced security may utilize methods of computer randomization, human, double blind verification, or numbered computer key programmed verification as well as a programmed computer system of checks, balances, verifications, data back up, encryption, parallel storage and firewalls for immediate diagnostic isolation and repairs in case of a security breach.

In a further embodiment of the invention, there is automatic processing through the Central Data Processing Warehouse so that all data, inclusive of actual transactions and projected transactions, is contained within a pre-set computer program to those criteria previously described in all claims and processed by the Central Data Processing Warehouse according to the criteria previously described. The automatic processing also assimilates new product suppliers and consumers to service their transactions in a similar manner.

In a further embodiment, a step may be included involving providing this representative sample(s) of the electronic personal computer wallet and its graphic interface functions, for consumer product search, selection, offers, and counteroffers; and product supplier offers, and counteroffers or to obtain or post products, goods, services, data, and information through the Master Catalogue Internet Catalogue.

This example of a graphic interface and design of the personal computer electronic wallet is only one example of numerous possibilities. The personal computer wallet can be any size.

A.) For purposes of this design example, the shape of the personal computer wallet may be in the shape of a flat egg about the size of a small woman's hand. The top half portion of the egg may be the larger oval and display screen. A mouse ball button may be embedded in the lower portion of the wallet and the button keyboard is located above that. Each personal computer wallet may be individualized based on, but not limited to, gender, age, income level, geographic region or other generalized demographic features.

Personalization of the personal computer wallet is a very important user feature for orientation, desirability, and simplicity. For example, a farmer may be more interested in the weather than a housewife. Where simplicity is desired the corresponding wallet main features are more accessible in the first or early screen modes.

B.) When you turn on your wallet, per the graphic interface, you are looking at your mirrored identity as displayed from your Origin Code. This mirrored identity means you are followed and you are known by the Central Data Processing Warehouse or select merchants and product suppliers. You are recognized for the places you visit, the products you buy, the products you anticipate on purchasing or the places journeyed to (more on this function to follow) for sampling or consideration. The initial graphic interface is your face (consumer profile with identity encryption) or what you want to see in the following ways;

C.) Your identity page has your access code entry as page one (a pin);

D.) You then move to page two with the WHAT function revealing a series of icons representing: 1. Messages, 2. Consumer Goods, 3. Energy and Transportation, 4. Travel, Meals, Entertainment, 5. Services, 6. Journey, 7. Automated Functions. Click on any of the seven icons above and you now flood the screen as a pool with subcategories. For example, Messages includes 1. My Discounts, 2. Coded Consumer Alerts, (specific to the Origin Code's past or anticipated purchases). Consumer Goods include 1. Stores, 2. Shopping List, 3. Hot Brands, 4. High Value Goods. Energy and Transportation includes 1. Car pooling, 2. Energy Savings. Travel, Meals and Entertainment includes 1. Meals 2. Vacations, 3. Hotels, 4. Events. 5. Services include 1. Repairs, 2. Body, 3. Car, 4. Home, and 5. Plans. Journey (being taken to a video display or graphic display advertisement(s) and product promotion or sample offer) includes 1. Stores, 2. Downloads 3. Kiosks, 4. Travel 5. Ads and Freebies Automated includes 1. My Discounts, 2. Shopping List, 3. Pools, 4. Product Alerts.

The Origin Code consumer is journeyed. They are new immersion experiences or popular discounts or known discounts: defined as the consumer is known through their consumer profile and is directed to a universe of consumer product choices. This need not be an actual anticipated purchase but may be promotional ads through the personal computer wallet and free sample offers.

E.) There are also two other main search functions which the consumer may access in any of the main icon fields just described. They are the “HOW” and “WHY” functions. The HOW function is defined as the function where the consumer wants to take more control of the purchase process. They want to know and be told what open pools they may be able to participate in and how the merchants are offering their discount methods to the masses. The WHY function is an automated function and is meant to lead the Origin Code. Examples include verifying the reasons for their shopping list, their prepay, and the reasons for their product choice directives. Other examples include blocking certain products they pick from the shelves, steering them to alternative lower cost brands of the same quality, and examining projected statistical analysis of anticipated price rises or lowering of the same. This will include in-depth graphical and numeric information. Examples include an in-depth analysis of a histogram, bar or pie chart wherein the pie chart is not merely flat, but three dimensional. This includes information related to the gathering of the statistical model for the numerical rational behind the consumer or business guided information, instruction or purchase/sale choice.

These functions are just ask functions with the key being that the right questions are asked at the simplest, earliest stage possible in this complex science. This is easier to do with the automated functions of the WHY mode and simplified in the HOW functions when the consumer is referring and asking about a specific product or domain name or store. Information related to who tracked the Origin Code is integrated into these functions. The personal computer wallet will have roaming functions where you can allow your code identity to be known, tracked, and followed. In the alternative, you may remain unknown and encrypted as an Origin Code. A semi private function can also be achieved by allowing people to be known by made up code names. The point is to allow for secure encryption of identity at a desirable level. However, the complete Origin Code profile may not always be entirely blocked. For example, being known at some familiar stores is often considered a privilege of the preferred consumer data card holder.

It should be understood, of course, that the foregoing relates to exemplary embodiments of the invention and that modifications may be made without departing from the spirit and scope of the invention as set forth in the following claims.

What is claimed is:

1. A method for improving the purchasing power and convenience of a pool of consumers, comprising:
allowing consumers to sign up at a web site as cardholders and provide data as to past purchases of products and services thereby establishing for each consumer a consumer purchasing profile, the consumer purchasing profile stored by a computer linked to the web site as an encrypted consumer identity code,
obtaining information from suppliers of products and services as to what discounts a supplier would provide if particular bulk offers were available,
conducting a statistical analysis of the consumer purchasing profiles,
generating an online master catalogue accessible to each consumer who signed up, the master catalogue listing a universe of products, each product identified by a product code identifier, each entry for a product containing data concerning criteria under which one or more of the suppliers would accept a bulk offer at a particular discount, the criteria including timing,
tutoring cardholders to use the master catalogue and to update the cardholder's consumer data profile without receiving unwanted solicitations,
consumer cardholders accessing the master catalogue from time to time and, under criteria set by suppliers for bulk offers, making commitments to purchase particular goods and services listed therein as part of the pool at discounted prices,
communicating bulk offers from the pool of consumers to suppliers for specific products and services in the master catalogue based on the statistical analysis by sending identity encrypted consumer data profiles to retailers online to induce discount bulk offers by the retailers on products and services listed in the master catalog,
processing acceptances and associated billing,
wherein suppliers are allowed to directly fix the percentage of discount in the master catalogue, said master catalogue being linked to the computer.

2. The method of claim 1, including providing a consumer card for each consumer in the pool, the consumer card comprising a portable card containing data history as to that consumer's past spending habits, the data history capable of being used to estimate future purchase needs of the consumer.

3. The method of claim 1, wherein the suppliers are allowed to pre-post the numbers of confirmed offers that would generate a specific price discount, at pre-specified levels, of confirmed offers received, for a product or product category or a department of the store, which would indicate an overall volume trade discount.

4. The method of claim 1, wherein the supplier is allowed to repeatedly drop a price set for the bulk offer lower and lower to attract increasing numbers of consumers into the product pool, for specified products, as more and more people make confirmed offers, until a lowest strike price is achieved for the entire pool.

5. The method of claim 1, including the step of setting a pre specified percentile discount, based on the amount of pre-dedicated capital the consumer is willing to allocate towards spending at the store.

6. The method of claim 1, including a specific percentile discount based on a consumer requirements agreement, for all products the consumers will use during some agreed upon cycle of time, and including renewing the cycle of the consumer's pre-dedicated capital or credit automatically based on past product usage.

7. The method of claim 1, wherein an amount of pre-dedicated capital is brand specific.

8. The method of claim 1, wherein there are multiple consumer pools and a consumer is not required by a supplier to be committed to being in a particular consumer pool.

9. The method of claim 1, wherein a supplier requires from each consumer in the consumer pool that the consumer commit to being in one consumer pool.

10. The method of claim 1, wherein a product supplier can ask consumers whether they are willing to accept an offer at a particular value.

11. The method of claim 10, wherein product suppliers can establish rewards for early commitments by a consumer.

12. The method of claim 1, wherein the system sets the criteria under which consumers can form pool offers.

13. The method of claim 12, wherein suppliers offer consumers discounts if the pool of consumers commits to an option to purchase, rather than to actually purchase, specific goods or services at a pre-specified price.

14. The method of claim 1, wherein the system advises the suppliers of the projected consumption rate of any anticipated bulk purchases.

15. The method of claim 1, including providing a discount for customers who shop regularly at a particular store.

16. The method of claim 15, including making use of a time threshold for an in store visit or product purchase or web site visit to meet the minimum eligibility standards to be considered a customer who shops regularly at the particular store.

17. The method of claim 15, including ways of steering customers to a store.

18. The method of claim 1, including establishment over a global telecommunications network of a universal master catalogue of product suppliers.

19. The method of claim 1, wherein consumers can regulate for a particular product or service an amount of solicitations received as pop up ads.

20. The method of claim 1, wherein consumers search for solicitations from product suppliers in the master catalogue.

21. The method of claim 1, wherein consumers can request advice from the system as to what to offer for a product for pooling.

22. The method of claim 1, wherein all consumer's offer data can be hidden from the product suppliers.

23. The method of claim 1, wherein product suppliers can offer product discounts that depend on purchase volume.

24. The method of claim 1, wherein statistics of a bulk sale are posted on the Internet to educate consumers on future offers.

25. The method of claim 1, wherein consumers do not receive an identical discount if there is a limited product supply.

26. The method of claim 1, wherein consumers do not receive an identical discount.

27. The method of claim 1, including a specialized part of the master catalogue called “My Discounts” describing an anticipated purchase profile of a particular cardholder, said profile being dispersed to product suppliers who reply with discount offers to an encrypted identity code of the cardholder.

28. The method of claim 1, including linking the consumer card to a battery operated personal computer wallet wherein consumer profile credit data is downloaded into an electronic personal computer wallet operated by computer chip.

29. The method of claim 1, including linking select data transactions to remote computer kiosks located at a site, the computer kiosks having display screens and linked to the Internet master catalogue and containing information on the site and on regional store information.

30. The method of claim 28, wherein the kiosk exhibits product information on the display screen and wherein the kiosk provides shoppers with a simulated walk through a virtual store or mall to an exact product location or store for virtual shopping.
